(19) United States
(12) Patent Application Publication
(10) Pub. No.: US 2024/0063894 A1
(43) Pub. Date: Feb. 22, 2024

(54) NEW RADIO DEVICE SUPPORT FOR NON-TERRESTRIAL NETWORKS IN IDLE MODE AND IN RRC INACTIVE STATE

(71) Applicant: INTERDIGITAL PATENT HOLDINGS, INC., Wilmington, DE (US)

(72) Inventors: Jerome VOGEDES, Milwaukee, WI (US); Pascal ADJAKPLE, Great Neck, NY (US); Yifan LI, Conshohocken, PA (US); Kyle PAN, Saint James, NY (US); Allan TSAI, Boonton, NJ (US)

(21) Appl. No.: 18/261,020

(22) PCT Filed: Jan. 12, 2022
(86) PCT No.: PCT/US2022/012086

§ 371 Date: Jul. 11, 2023

Related U.S. Application Data
(60) Provisional application No. 63/136,232, filed on Jan. 12, 2021.
(60) Provisional application No. 63/168,441, filed on Mar. 31, 2021.
(60) Provisional application No. 63/185,777, filed on May 7, 2021.

(51) Int. Cl. H04B 7/185; H04W 56/00

(52) U.S. Cl. CPC H04B 7/18513; H04W 56/0045

(57) ABSTRACT

User equipment in radio networks may be adapted to dynamically select connections to terrestrial and non-terrestrial cells in accordance with detected and/or signaled network properties, and adjust communication expectations for return trip times in accordance with timing and conditions encountered with non-terrestrial equipment, including non-geosynchronous high-altitude and/or low earth orbit equipment, and/or other equipment which is in motion relative to the earth and/or the user equipment. The types of equipment used in a cell, and/or ephemeris associated therewith, may be signaled by the network and/or determined by the user equipment via analysis of synchronization signals, for example.

### CROSS-REFERENCE TO RELATED APPLICATIONS

This application claims the benefit of U.S. Pat. App. Ser. 63/136,232, filed Jan. 12, 2021, titled “Radio device support for non-terrestrial networks in idle mode and RRC inactive state,” U.S. Pat. App. Ser. 63/168,441, filed Mar. 31, 2021, titled “New radio device support for non-terrestrial networks in idle mode and RRC inactive state,” and U.S. Pat. App. Ser. 63/185,777, filed May 7, 2021, titled “Radio device support for non-terrestrial networks in idle mode and RRC inactive state,” the content of which is hereby incorporated by reference herein.

### BACKGROUND

This disclosure pertains to the management of terrestrial and non-terrestrial network communications. See, for example, 3GPP TR 38.821, Solutions for NR to support non-terrestrial networks (NTN), (Release 16), V16.0; 3GPP TS 38.331, Radio Resource Control (RRC) protocol specification (Release 16); 3GPP TS 38.300, NR and NG-RAN Overall Description; Stage 2 (Release 16); 3GPP TS 38.304, User Equipment (UE) procedures in Idle mode and RRC Inactive state(Release 16); and 3GPP TS 38.321, Medium Access Control (MAC) protocol specification (Release 16).

### SUMMARY

User Equipment (UE) for radio communications may be adapted to communicate with a wide range of non-terrestrial cellular equipment in addition to terrestrial equipment such as terrestrial base stations. Non-terrestrial equipment may include, for instance, equipment that is not “earth moving” such as geosynchronous satellites, as well as earth-moving equipment such as systems mounted on aircraft, low earth orbit satellite, medium earth orbit satellites, and the like.

User equipment in radio networks may be adapted to dynamically select connections to terrestrial and non-terrestrial cells in accordance with detected and/or signaled network properties, and adjust communication expectations for return trip times in accordance with timing and conditions encountered with non-terrestrial equipment, including non-geosynchronous high-altitude and/or low earth orbit equipment, and/or other equipment which is in motion relative to the earth and/or the user equipment. The types of equipment used in a cell, and/or ephemeris associated therewith, may be signaled by the network and/or determined by the user equipment via analysis of synchronization signals, for example.

The selection of connections may be determined dynamically based on criteria that provisioned to user equipment, e.g., in uSIM, and/or signaled from various network resources. For example, information provided by terrestrial equipment in a first cell may be used to facilitate future selection and/or reselection of that cell or other terrestrial and non-terrestrial cells.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings. The drawings are not to scale.

FIG. 1 is a block diagram illustrating example NTN satellite orbits.

FIG. 2 is a block diagram illustrating a UE with TN and NTN coverage.

FIG. 3 illustrates an example of update and link frame timing.

FIGS. 4A and 4B are block diagrams illustrating example comparing NTN vs TN near-far effects.

FIG. 5 is a block diagram illustrating an example NTN transparent architecture.

FIG. 6 is a 3D graph illustrating NTN cell orbit parameters.

FIG. 7 is a call flow of an example automatic neighbor relation function.

FIG. 8 illustrates measurement gaps.

FIG. 9 is a flow diagram of an example of timing offset NTN implicit indication.

FIG. 10 is a flow diagram on an example process flow for UE detection of NTN cell by S1 scheduling information.

FIG. 11 illustrates and example MAC RAR structure.

FIG. 12 is a flow chart illustrating an example of modifications to MAC payloads.

FIG. 13 is a flow diagram of an example of NTN cell selection.

FIG. 14 is a flow diagram of an example of process for RSRP threshold.

FIG. 15 is a flow diagram of an example of RACH selection.

FIG. 16 is a call flow of an example ANR procedure to resolve PCI conflicts.

FIG. 17 is a flow diagram of an example of NTN SIB management.

FIG. 18A illustrates an example communications system.

FIGS. 18B-D are system diagrams of example RANs and core networks.

FIG. 18E illustrates another example communications system.

FIG. 18F is a block diagram of an example apparatus or device, such as a WTRU.

FIG. 18G is a block diagram of an exemplary computing system.

### DETAILED DESCRIPTION

### 2.1 Terminology

Table 1 of Appendix 1 describes many of the acronyms used herein.

### 2.2 NTN Use Cases and Deployment Scenarios

In 3GPP Release 16, there is currently no support for Non-Terrestrial Networks (NTN) platforms in NR (New Radio) UEs and Networks. An NTN refers to an access network that uses RF resources on-board a space-based or airborne vehicle/satellite to facilitate mobile communications.

The three general types of NTN platform types/constellations to be considered for support in 3GPP NR specifications: Geostationary Earth Orbit (GEO) constellations, High Altitude Platform Station (HAPS) constellations, and Non-Geostationary Orbit (NGSO) constellations. NGSO constellations include Low Earth Orbit (LEO) constellations, Medium Earth Orbit (MEO) constellations, and Highly Elliptical Orbit (HEO) constellations.

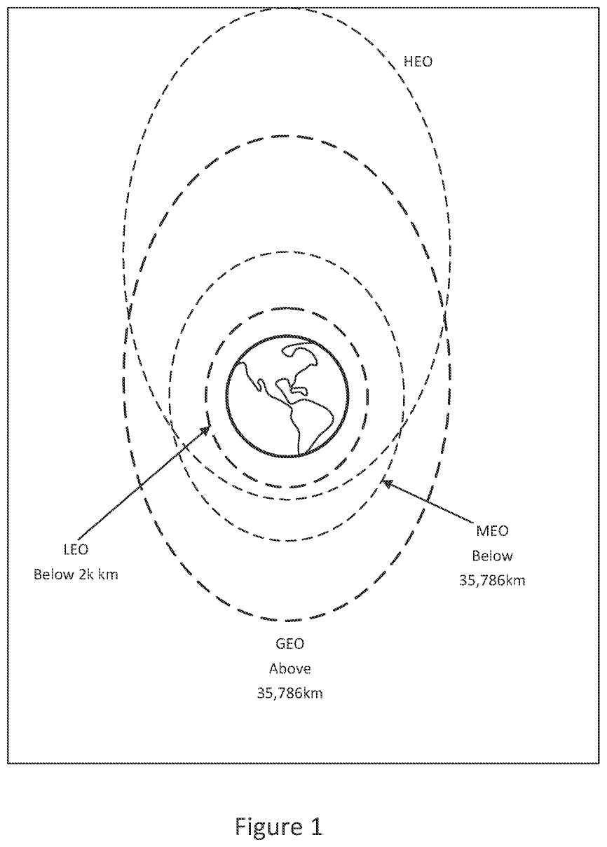

These NTN platform types are depicted in FIG. 1.

From the mobile network operator (MNO) perspective, there are several deployments that may be possible when supporting NTN in an NR environment. The simple case is an MNO deployment that only supports a standalone TN as is the case in 3GPP Rel-16 and earlier. In other future cases, an MNO deployment may involve support for one or more NTN platform types. In yet another alternative, MNOs may support both TNs and one or more NTN types.

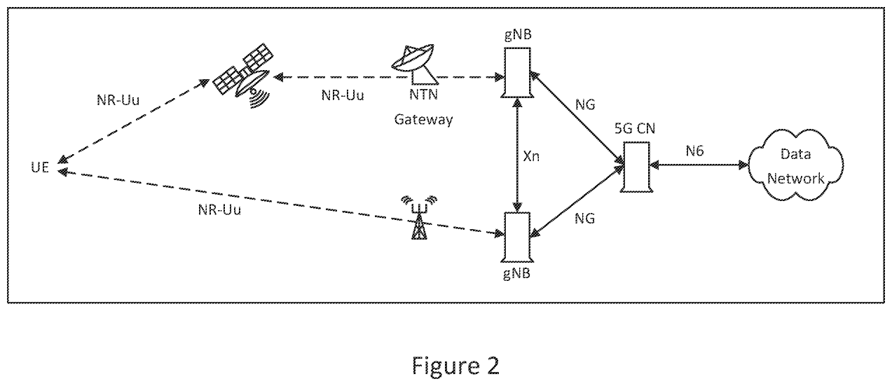

Therefore, it can be envisioned that from a network/RF coverage perspective, all of the following possibilities exist for the various deployment scenarios: TN coverage only; single NTN-platform coverage only; multiple NTN-platform coverage (e.g., earth-fixed, and earth-moving NTN cells); TN and one NTN-platform type; and TN and multiple NTN-platform types. See, e.g., FIG. 2.

It is important to note that for the NTN platform types may be deployed in the same frequency bands as a TN or another NTN platform type.

Similarly, from the potential UE support/type perspective, the following three possibilities will exist: UEs supporting TNs (Terrestrial Networks) only; UEs supporting NTNs only (one or more NTN types); and UEs supporting both TNs and NTNs (one or more NTN types).

Due to the distinct propagation, orbit, and delay characteristics for each of the various NTN types, there may be some specific advantages to each type of NTN platform, e.g.: LEO (less propagation delays, fast moving orbit with a short dwell time, may be earth fixed steered beams or moving beams); MEO (medium propagation delays, slower moving orbit than LEO); GEO (geo-stationary, large coverage footprint, long propagation delays and high latency); and HAPS (Lower latency, less propagation delays, and earth fixed coverage footprint).

Table 2 of Appendix 1 is adapted from Table 7.1-1 of TR 38.821 to show some of the specific delay and coverage footprint characteristics of the various NTN platforms.

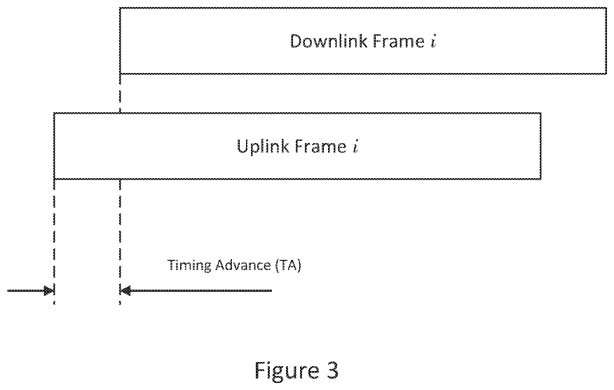

Generally, the challenges associated with NR support for NTN deployments are based on moving beams, high elevation orbits, and wide geographical coverage of NTN satellites (cells) result in significant increase in round-trip delay (RTD) and delay difference between UEs in the coverage area of an NTN cell as illustrated in Table 2. Types of NTN Platforms. The propagation delays in TNs are usually less than 1 mS. In contrast, the propagation delays in NTN are much longer, ranging from several milliseconds to hundreds of milliseconds depending on the altitudes of the SVs or airborne platforms and payload type in NTN. Dealing with such long propagation delays in NTN requires modifications of many timing aspects in NR from PHY layer to higher layers, including the Timing Advance (TA) mechanism. TA is a command sent by the gNB to UEs to adjust its UL transmissions, meaning that the UE sends UL symbols according to this adjustment in the time domain for e.g., PUSCH, PUCCH, relative to DL as shown in FIG. 3. Additionally, for NTN, there are two components of TA, one common TA associated with the RTD between the gNB and the satellite and a UE-specific TA component between the satellite and the UE. Existing NR TA commands in TNs have two flavors, initial TA command via RACH procedure (i.e., RAR message in either Msg2 in the case of 4-step RA or MsgB in the case of 2-step RA) and subsequent updates of TA command via MAC-CE (TS 38.821). These existing NR timing definitions involving DL-UL timing interaction will not hold when there is a large offset in the UE's DL and UL frame timing in NTN. Thus, the timing relationships will be enhanced for NTN support including a timing relationship offset for initial access. See TR 38.821 at 6.2.1.

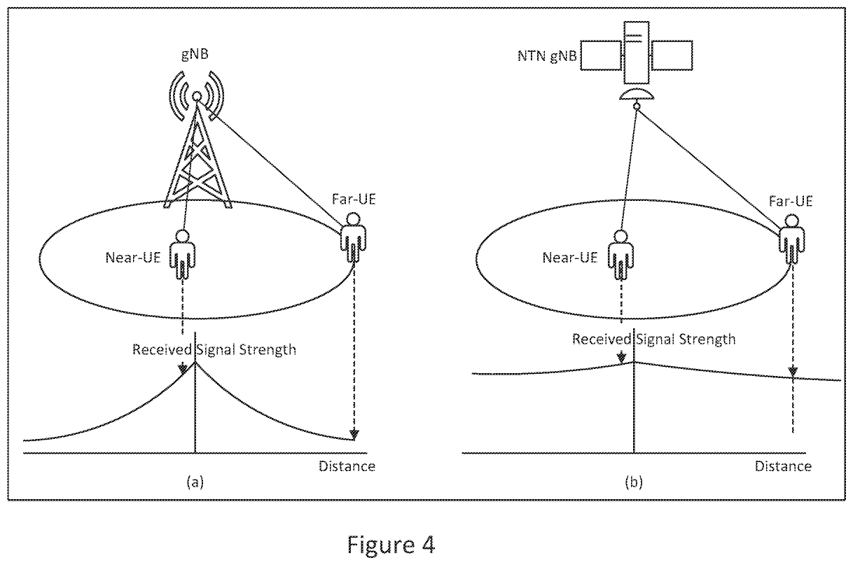

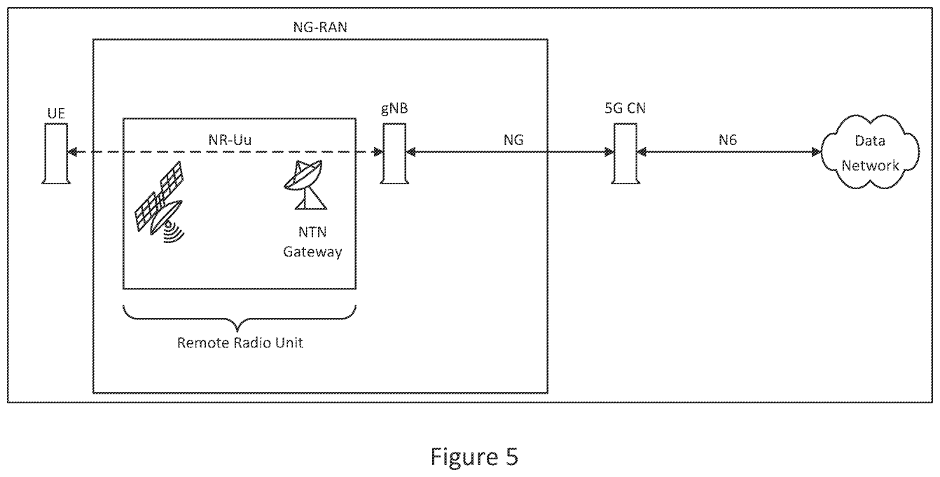

Another key attribute or side effect of the NTN characteristics is the lack of the near-far effect, which is present in TN and basis for measurement reporting and triggers. As shown in FIG. 4A and FIG. 4B, the RSRP/RSRQ measured by the UE may have no obvious difference due to the long physical distance from the UE and wide-area NTN coverage. Not only is there uniform RX power from an NTN cell, but potentially similar RX power from visible neighbor NTN cell(s).

From an NR architecture integration perspective, there are 2 general flavors that may be employed to incorporate NTN platforms into the existing NR framework, (1) transparent payload or (2) regenerative payload. The baseline Rel-17 NTN architecture will assume that the NTN cells (satellites) do not have gNB functionality nor processed payload and a “feeder link” (Satellite-to-gNB link) is required to connect to the gNB. That is, the NTN cell will essentially have a transparent payload to the UE and the Uu interface is terminated at the gNB (not the satellite vehicle) as in the case for NR. This baseline architecture is shown in FIG. 5.

However, the NTN baseline architecture (transparent satellite architecture) may be enhanced in the future (beyond Rel-17) as described in 3GPP TR 38.821 for NTN cells to support regenerative payloads. Specifically, for regenerative payloads, gNB functionality is located onboard SVs and will help reduce the impacts of the large propagation delays present in NTN deployments.

For on-board gNB (gNB processed payload, e.g., NR Uu interface is terminated at the satellite or potentially ISL—Inter-Satellite Links), there will be timing (e.g., propagation delays) differences as compared to transparent NTN architectures. This type of NTN architecture is important given the propagation delays for transparent mode but was not prioritized for the Rel-17 NTN work in 3GPP.

### 2.3 Cell (Re)Selection & Satellite Ephemeris Data

In TR 38.821, there are several NTN platforms, architectures, and configurations that are supported. As previously discussed, there are GEO, MEO, LEO and HAPS NTN platforms that support transparent mode SVs (Satellite Vehicles) and SVs that may also have gNB processed data. These SVs may also leverage beamforming that are steered to earth-fixed locations or those that are earth-moving beams. All of these potential architectures and overlapping configurations can be the target for cell (re)selections.

### 2.3.1 Cell Selection for TNs

Per TS 38.304, cell selection is performed by one of the following two procedures. The first procedure is for initial cell selection with no prior knowledge of which RF channels are NR frequencies. The UE shall scan all RF channels in the NR bands according to its capabilities to find a suitable cell. On each frequency, the UE need only search for the strongest cell, except for operation with shared spectrum channel access where the UE may search for the next strongest cell(s). Once a suitable cell is found, this cell shall be selected.

The second procedure is for cell selection by leveraging stored information. This procedure requires stored information of frequencies and optionally also information on cell parameters from previously received measurement control information elements or from previously detected cells. Once the UE has found a suitable cell, the UE shall select it. If no suitable cell is found, the initial cell selection procedure in a) shall be started.

NOTE: Priorities between different frequencies or RATs provided to the UE by system information or dedicated signaling are not used in the cell selection process.

In NR for TN cell selection, UEs implement the S-criterion to select a cell with qualified RSRP and RSRQ and generally, the same principles should be kept to ensure that the UE selects a cell with good RX level/quality. In traditional TN settings, the cell selection S-criterion is fulfilled when:
Srxlev>0 AND Squal>0

where: Srxlev=Qᵣₓₗₑᵥₘₑₐₛ−(Qᵣₓₗₑᵥₘᵢₙ+Q_{rxlevminoffset})−P_{compensation}−Qoffsettemp

Squal=Q_{qualmeas}−(Q_{qualmin}+Q_{qualminoffset})−Qoffsettemp

where:

See Table 3 Appendix 1, S-criterion parameters.

Additional cell selection criteria include:
PLMN of the cell acceptable to the UE (PLMN selection criteria)
   Match PLMN stored on uSIM
Service type of the cell acceptable to the UE

### 2.3.2 Cell Reselection for TNs

For the NTN cell reselection evaluation process, based on 38.304 and corresponding RRC specification as a starting point, legacy cell reselection criteria include an absolute priority configuration as shown in the appropriate RRC field descriptions for CellReselectionPriority and sub-priority.

The IE CellReselectionPriority concerns the absolute priority of the concerned carrier frequency, as used by the cell reselection procedure. Corresponds to parameter “priority” in TS 38.304. Value 0 means lowest priority. The UE behavior for the case the field is absent, if applicable, is specified in TS 38.304.

The IE CellReselectionSubPriority indicates a fractional value to be added to the value of cellReselectionPriority to obtain the absolute priority of the concerned carrier frequency for E-UTRA and NR. Value oDot2 corresponds to 0.2, value oDot4 corresponds to 0.4 and so on.

For cell re-selection in NR TNs, UEs follow the reselection priority configured via system information or RRCRelease messages for each frequency and reselects to the best cell (highest ranked cell based on R-criterion) assuming that the cell is not barred/reserved. The R-criterion, cell-ranking criterion Rs for a serving cell and Rn for neighboring cells is defined by:

Rₛ=Q_{meas,s}+Q_{hyst}−QOffsetₜₑₘₚ

Rₙ=Q_{meas,n}−Qoffset−Qoffsetₜₑₘₚ

where:

| Qₘₑₐₛ | RSRP measurement quantity used in cell reselections. |
|---|---|
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in TS |
| | 38.331. |

The UE performs ranking of all TN cells that fulfil the cell selection criterion S. The TN cells shall be ranked according to the R criteria by deriving Qmeas,n and Qmeas,s and calculating the R values using averaged RSRP results.

Leveraging these existing NR procedures, UEs will receive Cell reselection priorities in the SI or RRCRelease message. Then the UEs can rank the cells for frequencies with highest priority based on R-criterion and read the SI of the highest-ranking cell to see if it is suitable to camp on.

TS 38.304 also defines rules to limit intra- and inter-frequency measurements. To evaluate cell reselection and measurement rules for TNs, the following three rules are used by the UE to limit needed measurements.

First, if the serving cell fulfils Srxlev>SIntraSearchP and Squal>SintrasearchQ, the UE may choose not to perform intra-frequency measurements. Otherwise, the UE shall perform intra-frequency measurements.

Second, the UE shall apply rules for NR inter-frequencies and inter-RAT frequencies which are indicated in system information and for which the UE has priority provided

Third, if the UE supports relaxed measurement and relaxedMeasurement is present in SIB2, the UE may further relax the needed measurements. UE Mobility states are also defined based on the number of reselections during a specified timeframe. This can be used to determine measurement relaxation in TN environments.

### 2.3.3 Ephemeris and UE Location

An agreement for Release 17 in the NTN WID and TR 38.821 provides that UEs are assumed to support GNSS (e.g., GPS) for positioning capabilities. Location of the UE with respect to satellite position can significantly aid the UE during idle, inactive, and connected mode procedures.

Satellite ephemeris data and UE location information together can be used to help UEs perform measurements and cell (re)selection. See TR38.821.

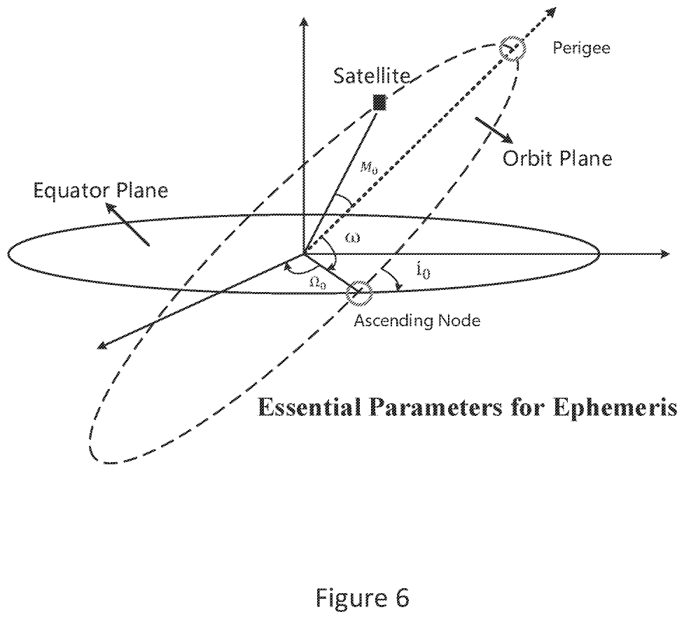

Ephemeris data contains the information about the orbital trajectories of artificial satellites. There are different possible representations of ephemeris data for NGSO SVs and coordinates for GEO SVs. One possibility is to use orbital parameters, e.g., semi-major axis, eccentricity, inclination, right ascension of the ascending node, argument of periapsis, mean anomaly at a reference point in time, and the epoch. The first five parameters can determine an orbital plane, and the other two parameters are used to determine exact satellite location at a time. A description table for the orbital parameters and the corresponding illustrations in FIG. 6 are as in Table 4 of Appendix 1, Essential Elements of Ephemeris. See TR 38.821.

### 2.4 Two-Step Vs Four-Step RACH

In Rel-16, 2-step RACH was standardized as an enhancement to existing traditional 4-step RACH procedures. In NTN, 2-step RACH is preferred given long transmission delays and the potential for one less round trip.

The criteria for selection of 2-step RACH versus 4-step RACH from TS 38.321 sections 5.1.1 is solely based on RSRP, given a strong signal should be present for sending additional payload in msgA. The current Rel-16 specification is as shown below Exhibit A of Appendix 2.

### 2.5 Automatic Neighbor Relations

ANR is a key concept in SON (Self Organizing Networks). TS 38.300 describes the ANR function that resides in the gNB and manages the Neighbor Cell Relation Table (NCRT). Located within ANR, the Neighbor Detection Function finds new neighbors and adds them to the NCRT. ANR also contains the Neighbor Removal Function which removes outdated NCRs. The Neighbor Detection Function and the Neighbor Removal Function are implementation specific.

An existing NCR from a source cell to a target cell means that gNB controlling the source cell: (a) knows the global and physical IDs (e.g., NR CGI/NR PCI, ECGI/PCI) of the target cell; (b) has an entry in the NCRT for the source cell identifying the target cell, and (c) has the attributes in this NCRT entry defined, either by OAM or set to default values.

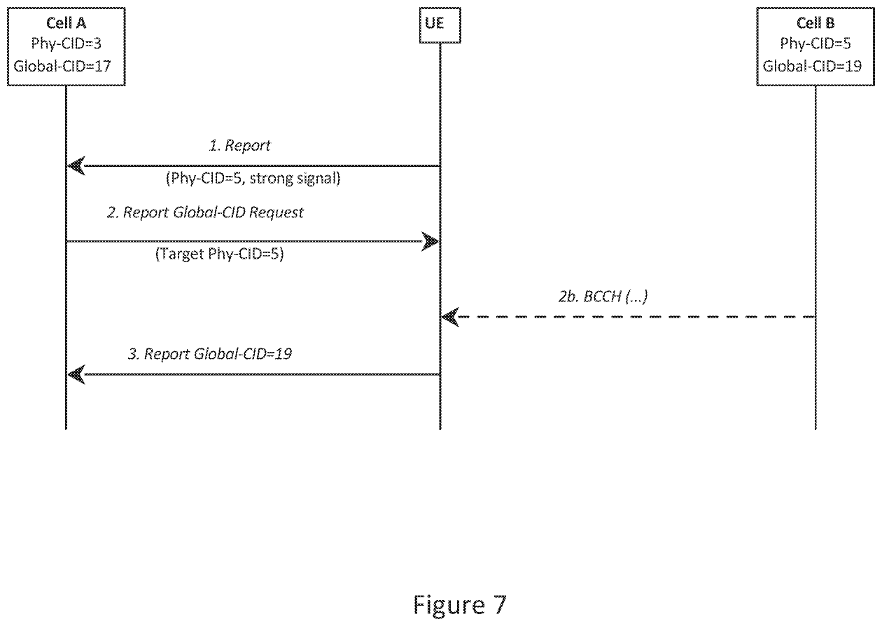

The FIG. 7 depicts an example where the NG-RAN node serving cell A has an ANR function. In RRC_CONNECTED, the NG-RAN node instructs each UE to perform measurements on neighbor cells. The NG-RAN node may use different policies for instructing the UE to do measurements, and when to report them to the NG-RAN node. This measurement procedure is as specified in TS 38.331 and TS 36.331.

First, the UE sends a measurement report regarding cell B. This report contains Cell B's PCI, but not its NCGI/ECGI. When the NG-RAN node receives a UE measurement report containing the PCI, the following sequence may be used.

Second, the NG-RAN node instructs the UE, using the newly discovered PCI as parameter, to read all the broadcast NCGI(s)/ECGI(s), TAC(s), RANAC(s), PLMN ID(s) and, for neighbour NR cells, NR frequency band(s). To do so, the NG-RAN node may need to schedule appropriate idle periods to allow the UE to read the NCGI/ECGI from the broadcast channel of the detected neighbour cell. How the UE reads the NCGI/ECGI is specified in TS 38.331 and TS 36.331.

Third, when the UE has found out the new cell's NCGI(s)/ECGI(s), the UE reports all the broadcast NCGI(s)/ECGI(s) to the serving cell NG-RAN node. In addition, the UE reports all the tracking area code(s), RANAC(s), PLMN IDs and, for neighbour NR cells, NR frequency band(s), that have been read by the UE. In case the detected NR cell does not broadcast SIB1, the UE may report noSIB1 indication as specified in TS 38.331.

Fourth, the NG-RAN node decides to add this neighbour relation and can use PCI and NCGI(s)/ECGI(s) to: (a) lookup a transport layer address to the new NG-RAN node; (b) update the Neighbour Cell Relation List; and (c) if needed, setup a new Xn interface towards this NG-RAN node.

### SMTC and Measurement Gaps

For TN NR, UEs must be able to measure neighboring cells signal strength (RSRP/RSRQ). Today, UEs are equipped with a single RF module due to device complexity/costs/size and must perform all of these additional measurements along with decoding SSB data.

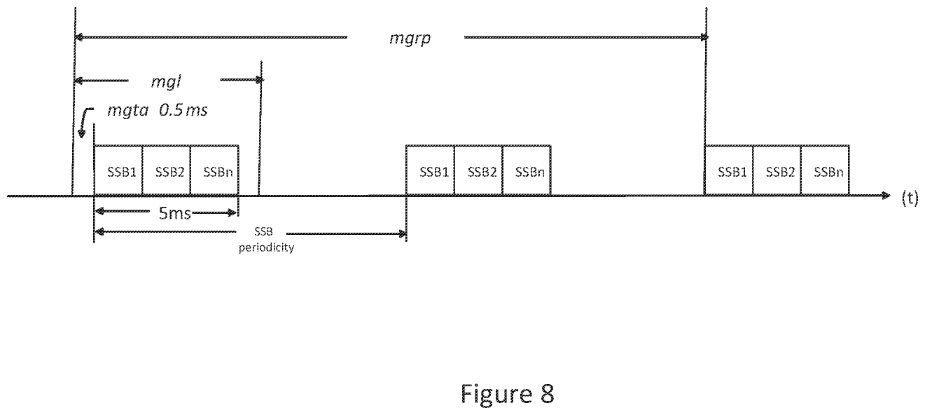

To measure neighboring NTN cell SSBs, the UE must detect these SSB burst sets within various periodicities as shown in FIG. 8. SSB sets occupy the 1st or 2nd half of each NR (10 ms) frame with the number of SSBs transmitted within a burst set determined by carrier frequency (4, 8, 64 SSBs). SSB Bursts are transmitted in periodicities of {ms5, ms10, ms20, ms40, ms80, ms160}.

### Measurement Gaps

FIG. 8 also represents the associated parameters for measurement gaps and are also represented in RRC in Software Example 2 of Appendix 1. Measurement gap config may include configurations for gapFR1, gapFR2, or gapUE (FR1 and FR2). Measurement Gap Length (mgl) is the length of measurement gap in mS. Measurement gap lengths can 1.5, 3, 3.5, 4, 5.5, and 6 mS.

Measurement Gap Repetition Period (mgrp) defines the periodicity (in ms) at which measurement gap repeats. It can be configured as 20, 40, 80, and 160 mS.

Measurement Gap Timing Advance (mgta) is an offset where the UE starts the measurement mgta ms before the gap subframe occurrence occurring immediately before the measurement gap in case the start of the SMTC window overlaps with the retuning time (RF retuning time in the 0.5 ms before and after the actual measurement window). The amount of timing advance can be 0.25 ms (FR2) or 0.5 ms (FR1). See Software Example 1 of Appendix 1, RRC representation for Measurement Gaps.

Agreements in RAN2 #113e included the following: RAN2 understanding that UE shall not be forced to detect the SSB burst outside the corresponding configured SMTC window in NTN, just like the principle in TN. SMTC and measurement gap configuration in NTN are configured based on the timing of PCell.

### 3 Example Challenges

### 3.1 Issue 1: Network Identification and Selection

For mixed network deployments (scenarios 3-5 in section 2.2) that support both TN and NTN platforms, there may be UEs that are not NTN capable. These UEs should only search and select TN cells. Likewise, UEs supporting only NTNs should also search and select NTN cells. Methods and behaviors should be defined to avoid the scenario when UEs not capable of a particular platform, may attempt access. Differentiating between networks and network types from a UE perspective will be essential given NTNs/TNs may be deployed in the same bands and PLMN IDs may also not differentiate the network/platform type.

Additionally, UEs supporting both TNs and NTNs will be able to select between the two network types and potentially more than one NTN type. Methods and procedures are necessary to identify and select the appropriate platform and NTN platform type.

Based on these potential deployment scenarios, UE capabilities and preferences for a given network platform, the awareness of a network type (NTN versus TN) will be helpful for the UE to find a suitable cell for cell search and cell (re)selection procedures. Latency reduction associated with scanning RF channels may also be beneficial given already long propagation delays. Further aspects of NTN identification for the UE are the implication of NTN (and NTN type) selection to invoke additional, necessary NTN-specific procedures and processes given the distinct latency and UL synchronization challenges (e.g., compensation for RTD) versus TN operations.

### 3.2 Issue 2: NTN Cell Selection

For mixed deployment scenarios as described in section 2.2, characteristics of NTN platforms deviate from existing TNs, including the relatively small changes in UE received signal strength from cell center to cell edge. Based on the FIG. 3, using only the measured RSRP/RSRQ (S-criterion) of the NTN cells would not be sufficient criteria for cell selection, and mitigate the number of immediate reselections. For example, a UE may camp on an NTN moving cell that is low on the horizon as the “best cell” due to a direct line of sight (LOS), but this NTN cell may not be suitable for selection if another NTN cell with a slightly lower S-criterion value (based on the S-criterion as described in 2.3) is overhead and/or will be visible to the UE for a much longer duration. For this reason, procedures for cell selection in the context of network deployments for NTN should be enhanced.

For the deployment scenario #3-#5 based on section 2.2 defined by a deployment with Multiple NTN-platform coverage (e.g., earth-fixed and earth-moving NTN cells) and possibly TNs, there may be multiple platforms with overlapping RF coverage at certain instances (geo-locations and time). In this case, there may be insufficient information available to the UE to know which platform should be prioritized and selected. It can be envisioned that the network will prefer to establish priorities for cell selection for the UEs in the presence of multiple TN/NTN architectures. The UE may also have requirements to operate on each of the NTN cell types (timing and frequency compensation requirements), therefore enhancements from existing TN methods are required. Satellite ephemeris and UE location could be leveraged to aid in cell selection, but to what extent (see section 3.6). Subsequent to cell selection and part of initial access procedures, if a UE selects a gNB which is served via an NTN cell, additional information is required for the UE to achieve and maintain network synchronization and determine UL scheduling. Due to the challenges associated with extreme propagation delays, propagation delay variability, and propagation delay differences between UEs, RAN2 has discussed TA pre-compensation reporting and agreed that at least for UL scheduling adaptation, the UE may report information about the UE-specific TA pre-compensation. RAN2 also agreed that UE reports the UE-specific TA pre-compensation during RACH procedure using MAC-CE.

### 3.3 Issue 3: NTN Cell Re-Selection

Similarly, for the deployment scenario #3-#5 based on 2.2 defined by a deployment with Multiple NTN-platform coverage (e.g., earth-fixed and earth-moving NTN cells) and possibly TNs, there may be multiple platforms with overlapping RF coverage at certain instances (geo-locations and time). In this case, there may be insufficient information available to the UE to know which platform to perform cell reselection to. Satellite ephemeris and UE location could be leveraged to aid in cell reselection, but to what extent (see section 3.6).

The cell reselection criteria, as currently specified, are insufficient by the same rationale as described for cell selection and should be enhanced. In addition, ping-ping between TN and NTN, or even between the various NTN-types (e.g., GEO/LEO) and high numbers of reselections, resulting in increased power consumption should be avoided.

Re-selection priority handling should be enhanced to address these issues. Specifically, cell ranking (R-criterion) is strictly designed for TNs, and not optimized for fast-moving NTN cells or cells (and neighbor cells) that lack near-far signal strengths, making cell re-selection challenging.

Additionally, TN rules as discussed in section 2.3 to limit intra- and inter-frequency measurements (relaxed measurements) are not valid for NTN platforms. The criteria to determine mobility states in earth-moving cells deployments should be redefined as there will be high number of re-selections with moving cells. Mobility aspects in these cases will have an impact on measurement rules in these deployments as defined for TN and should also be enhanced from the existing procedures.

### 3.4 Issue 4: 2-Step Vs. 4-Step RACH Selection

The criteria for selection of 2-step RACH versus 4-step RACH per TS 38.321 is solely based on RSRP. However, for NTN, there is little to no near-far effect. All UEs served by an NTN cell should have similar RSRP levels, thus making the TN criteria based on RX signal measurements insufficient. Granted that there may be some variations due to multipath for LOS vs NLOS UEs, however, other criteria and methods should be defined to determine the RA selection (e.g., cell edge/center determination via Satellite ephemeris).

### 3.5 Issue 5: NTNAutomatic Neighbor Relations Enhancements

Leveraging existing ANR (Automatic Neighbor Relations) techniques to solve PCI confusion in order to support co-channel operation between HAPS/moving cells & TNs was identified in the Rel-17 NTN work item as a potential area for enhancements over existing TN techniques.

There is the distinct possibility for earth-moving NTN cells (NGSO, e.g., LEO and MEO) and newly deployed HAPS to unintentionally create the following PCI conflict scenarios as these cells may come in close proximity to TN cells, or other NGSO or GEO cells/platforms, e.g., where Cell A and Cell B, each with the same PCI, become neighbors that results in a PCI collision. There should be some mitigation for these scenarios in a dynamic fashion as the PCI conflicts may result in RLF/HO failures.

### 3.6 Issue 6: Satellite Ephemeris Management for NTN Deployments

The NTN Work Item and TR 38.821 specify that satellite Ephemeris information should be defined and utilized by UEs to assist in cell (re)selection. There are two aspects for satellite ephemeris for NTN deployments. First. what information is included in the ephemeris data and how it will be defined? Consideration should be made on the size of the satellite ephemeris data per section 2.3. Second, how will UEs obtain, manage, and update ephemeris data?

### Issue 7: SMTC Measurement Gap Configuration in NTN Scenarios

In terrestrial networks, SMTC measurement gap configuration is based on the timing of PCell. However, in NTN scenarios, this causes an issue since there may be a significant propagation delay difference between the serving NTN cell and neighboring NTN cell(s).

SMTC measurement gap configuration must consider the propagation delay delta between NTN cells, otherwise the UE may miss the SSB/CSI-RS measurement window and will thus be unable to perform measurements on the configured reference signals. This problem may be present for various NTN types/scenarios, including for NGSO scenarios as large cell footprints may have significant propagation delay differences.

Following was captured in the TR 38.821: The network can compensate for propagation delay differences in the UE measurement window, e.g., via system information, or in a UE specific manner via dedicated signalling. Other solutions to this issue are not precluded.

### SMTC Measurement Gaps for NTN

System and Method to enable SMTC measurement gap configurations for NTN-enabled UE, in the presence of one or more NTN platform and/or cell types, may include one or more of the following five aspects.

First, the UE may transmit location and/or timing measurements to the network.

Second, MG configurations associated timing offsets/adjustments may be UE aided or network derived/aided or both. The MG configuration could be specific to a UE, multiple UE in same vicinity, or the same frequency with a larger and/or dynamic measurement window.

Third, a UE may receive from the network a MG offset pre-configuration to adjust/compensate for timing relationships between serving cell propagation delay and neighbor cell(s) propagation delay, differentiated by NTN cell type.

Fourth is MG time-related parameters specific to NTN scenarios including, but not limited to, gap offset, MG length, MG repetition period, and MG timing advance.

Fifth is reception by UE, from the network, RRC measurement configuration message(s) inclusive of a MG configuration, the MG configuration timing-related parameters relative to the serving cell NTN scenario type and a plurality of additional MG configuration timing-related parameters relative to the propagation delay of neighbor NTN cells as determined by one or more of the following: satellite ephemeris data for earth-fixed or moving NTN cells and UE location; UE Timing measurements (e.g., RTT); time relationship between serving and neighbor NTN cells; NTN cell orbit type and altitude (e.g., LEO, MEO, GEO, HAPS); timer or time of day; and priority related to cell (re)selection NTN type.

### 5 Example Solutions

### 5.1 Solutions for Problem Statement 1: NTN Platform Indication

NTN platform indication serves as a method for the UE to distinguish between multiple network platforms and more granular, platform types in mixed TN/NTN deployments or where UEs do not support a particular platform type. It is also envisioned that UEs will be able to support both TNs and NTNs, with NTNs consisting of several various satellite constellation types. There are two general methodologies proposed herein for NTN platform indication. They may be used singly or in combination.

First, NTN platform indication may be signaled to the UE in an explicit way by the gNB to assist the UE in making decisions for cell (re)selection. For simplicity, this does not introduce any ambiguity from the UE perspective, but requires a definition of new indicators(s).

Second, NTN platform indication may be implied from other, already available information that is already signaled from the gNB to the UE. This does not introduce any additional overhead as far as signaling a separate indication and does not require definition of a separate indicator.

One example of explicit indication of platform type could be a flag set in the existing MIB that is broadcasted by gNBs to UEs. There is only one spare bit available in the current Rel-16 MIB defined today, but this could be used to distinguish between TN versus NTN. This indicator could be used along with some additional system information to determine a particular type of NTN.

One type of implied indication could be frequency layer identification to determine the platform type. In this case, the UE could be pre-configured to associate a frequency band with a particular platform (TN/NTN, or NTN type). However, it should be noted that TNs and NTNs may be deployed in the same bands.

As described herein, the NTN identification methods could be used in combination or as standalone procedures.

It is envisioned, from this identification of the platform and NTN platform type as identified at the UE, methods further comprising platform and cell prioritization or selection. Furthermore, the UE may use criteria such as preferences, UE capabilities, mobility, device type (e.g., IoT), service requirements, and Quality of Service. This may be inclusive of latency requirements, bit error rate/packet loss, network congestion, bandwidth requirements, etc.

Network may provision UE with initial and subsequent updates of the platform priorities via OTA, device management, and various other techniques and delivery mechanisms.

### 5.1.1 Timing Offset for Initial Access Broadcast from NTN Cells

With the assumption that a timing relationship offset is necessary and to be delivered to the UE from the network for initial access, the existence of this offset can be inferred by the UE to determine not only that the platform of the cell is NTN, but also that the platform is of a specific NTN type.

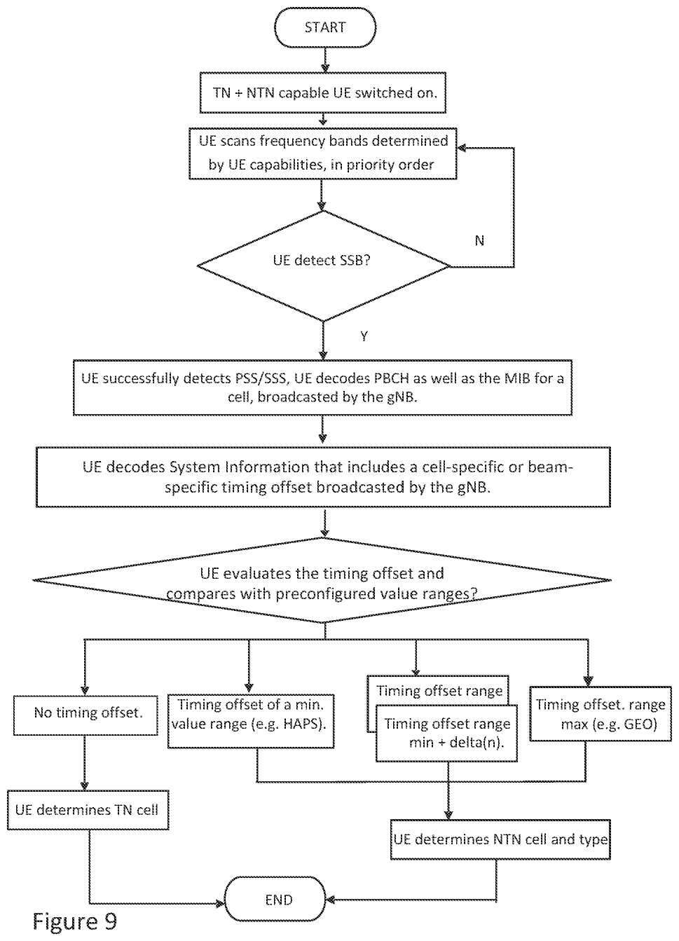

This is possible given the relationship between the amount of timing relationship offset specific to a given NTN platform deployment. That is, low-orbiting SVs will require a smaller timing offset versus a high altitude-orbiting SV. Based on the offset (or offset range), an NTN-capable UE can determine the NTN platform. As shown in the process flow FIG. 9, the UE can not only determine the platform type, but distinguish between the various NTN types.

Note that the first steps are known in the art for initial cell search. Once the NTN capable UE is switched on, based on the UE capabilities, scans the frequency band on sync raster indicating the frequency positions to detect the SS Block. After the UE detects PSS/SSS and decodes PBCH, as well as the MIB for a cell, it will be able to decode SIB1.

It is proposed to include a timing relationship offset for the cell and such timing relationship offset may also be beam-specific, broadcasted from the gNB for initial access. From the timing relationship offset value included in system information (e.g., MIB, SIB1 encoding or payload), the UE will be able to determine the platform type. For example, if the timing relationship offset value is signaled to the UE in the SI for a HAPS cell, it will have a minimum offset value of any of the supported NTN platform types (e.g., HAPS, LEO, MEO, GEO). This timing offset value range to determine the HAPS NTN cell is stored on the UE for reference. Similarly, LEO, MEO and GEO NTN cells will all have increasingly higher ranges of timing relationship offset values. However, for the various NTN types, the timing offset may vary by different SSB (or beam). Therefore, the network must ensure the min/max timing offset for a SSB in platform A will not overlap with the timing offset in Platform B. Hence, it can be assured that there is no ambiguity to use timing offset as the metric for distinguish between TN and NTN and this will enable the NTN-capable UE to determine these associated NTN cell types.

Alternatively, if there is no value or missing value for the timing relationship offset (note this may be separate from TA), the UE can assume that the cell is TN platform.

Furthermore, the determination of Platform type as well as specific NTN type can be leveraged for platform prioritization and cell (re)selection.

### 5.1.2 Presence of NTN-Specific SIB

There are two approaches that may be used singly or in combination. In the first approach NTN cells are determined by System Information Blocks (SIBs) either in an NTN-specific SIB or an existing SIB modified to support NTN system information. In this case, SIB1 would be broadcasted by the gNB and indicate that there exists NTN SIB(s) to be scheduled.

Second, SI (if Satellite ephemeris is included) would also determine the type of NTN, e.g., GEO, LEO, HAPS, etc. For example, a Non-geostationary orbiting satellite would likely have additional parameters for trajectory, velocity, etc. or formatted/encoded differently based on platform type.

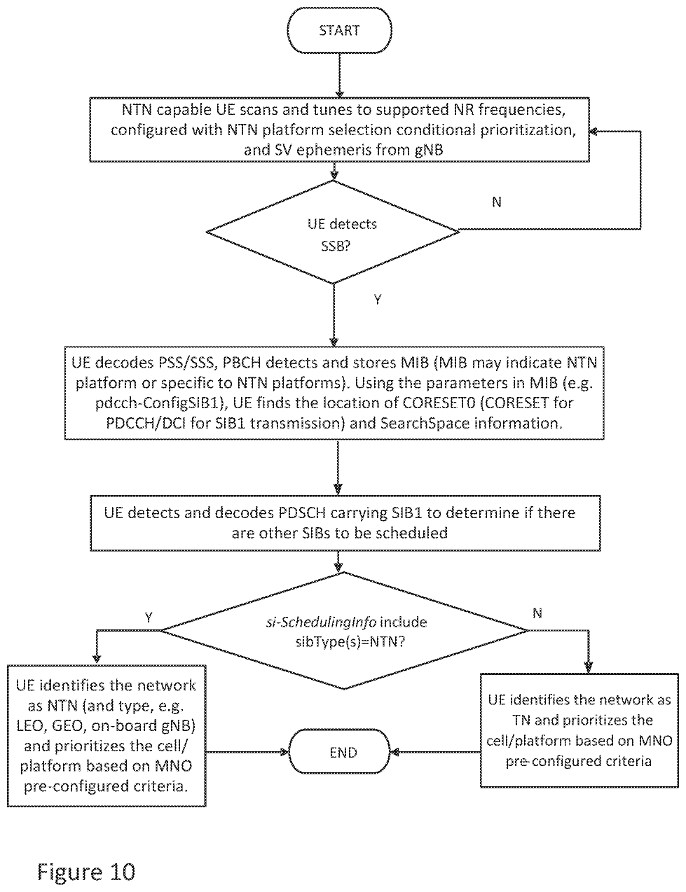

In the simplest form, the mere existence of NTN System Information can enable the UE to determine the platform supported by the cell is NTN. FIG. 10 illustrates such a case.

Since the UE may have to decode and process additional system information to determine the type of NTN cell, in some alternative embodiments, a spare bit in the MIB may be added to indicate NTN platform (if the is flag not present, a TN platform is assumed). This may be utilized in combination with some other control information (e.g., implicit indication in the MIB) or explicit/implicit indication in SIB1 to determine the NTN type in case the indicator in MIB indicates NTN platform. If the UE does not support NTN, the UE may ignore the cells with the additional indication for NTN type (e.g., LEO, MEO, GEO, etc.). If the UE does not support TN, the UE may ignore any TN cells that are broadcasting without the NTN indicator.

### 5.1.3 UE Report Configuration Based on NTN Identification

Regardless of the implicit, explicit, or any combination thereof for the identification method of an NTN platform as discussed, the identification can trigger or determine further UE configuration and actions. Given the timing and location-sensitive nature for NTN cell (re)selection and idle mode procedures, if a UE identifies a cell as an NTN cell, this information may be implicitly used as both a trigger and automatic configuration of a UE to report various TA and location (position) information to the network.

For example, there may be some pre-configuration for reporting of UE-specific (UE calculated/determined) timing and position determined for each Network type or NTN cell type. The pre-configuration may include one or more such factors such as: UL grant/resource allocation for potential reports; when to report (time associated with the report to be sent to the network); thresholds associated with generation and transmission of UE reports, e.g., based on UE mobility; granularity/accuracy requirements for the reports, and; periodicity (frequency) of UE-specific timing (e.g., TA for UE to satellite) and position reporting.

With certain NTN platforms (e.g., LEO, MEO, GEO, HAPS), it may be essential to have UE reporting configurations tailored to the serving NTN cell platform. For example, depending on the NTN cell type, more or less frequent UE timing or position reporting is required.

In addition to UE-generated reports, the UE, based on the NTN cell type identification, can also further determine configuration for timing relationship parameters to maintain uplink network synchronization, which may include; initial Timing Advance (common TA for the link between the RAN and the satellite) or a timing advance gradient (e.g., constant and predictable changes to TA). Both the TA and TA gradient can be determined by the NTN cell type, satellite ephemeris data, and/or UE location.

The configuration of the UE for both pre-configuration of reporting of UE-specific timing (service link between UE and NTN cell/satellite) and position based on the NTN cell type identification, and pre-configuration of TA/timing related parameters may be accessed via USIM, ME, and/or OTA methods in a priori of UE connectivity to NTN cell.

It may also be envisioned for the UE-generated reports to be further configured by the Network during Random Access procedures or configured in combination with some pre-configuration after the UE has completed NTN platform identification. Existing procedures for RA may be enhanced to include additional instructions from the Network for the UE, specifically contained within additional MAC payload for Random Access Response (RAR), or MSGB in the case of 2-step RA. Since TA command and UL Grant are part of the existing MAC payload for the Network to deliver to UEs, it may be envisioned to include the TA command configurations and UL grant associated with UE-generated reports as described herein. To minimize overhead associated with the Network sending the configuration for TA commands and reporting, the Network may activate a pre-configuration (index) that the UE use as determined by identified NTN cell type (or constellation, Cell group, etc.) via additional bit(s) included in the MAC payload. Alternatively, a new NTN specific RAR MAC payload may be defined or for further timing maintenance a Timing Advance Command MAC CE with UE reporting configuration for UE-specific TA (UE to NTN cell/satellite). To further illustrate this example, below is an update to the existing 38.821 specification, using section 6.2.3, MAC payload for Random Access Response as a baseline:

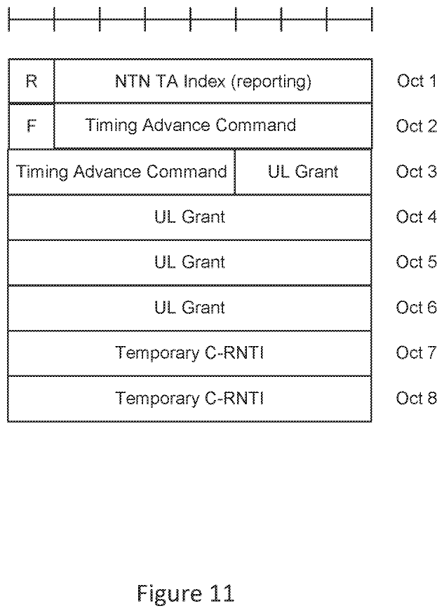

The MAC RAR is of fixed size as depicted in FIG. 11 and consists of the following six fields.

R: Reserved bit, set to “0”;

NTN UE-specific TA report config: This field indicates the periodicity, required accuracy/granularity, mobility threshold for reporting, reporting periodicity, etc. or TA reporting index.

NTN TA reportingflag: Flag to invoke the NTN pre-configuration for UE-specific TA reporting

TimingAdvance Command: The Timing Advance Command field indicates the index value TA used to control the amount of timing adjustment that the MAC entity has to apply in TS 38.213. The size of the Timing Advance Command field is 12 bits and is specific to the NTN feeder link (Satellite-to-gNB link) and may be an estimate of initial RTD or a specific TA index as determined by the NTN cell type;

UL Grant: The Uplink Grant field indicates the resources to be used on the uplink in TS 38.213. The size of the UL Grant field is 27 bits;

Temporary C-RNTL The Temporary C-RNTI field indicates the temporary identity that is used by the MAC entity during Random Access. The size of the Temporary C-RNTI field is 16 bits.

The MAC RAR is octet aligned.

Based on FIG. 11, further modifications to MAC payloads may be envisioned for UE-specific TA reporting and/or NTN-specific TA parameters, for, e.g., Msg B for 2-step RA, subsequent TA maintenance.

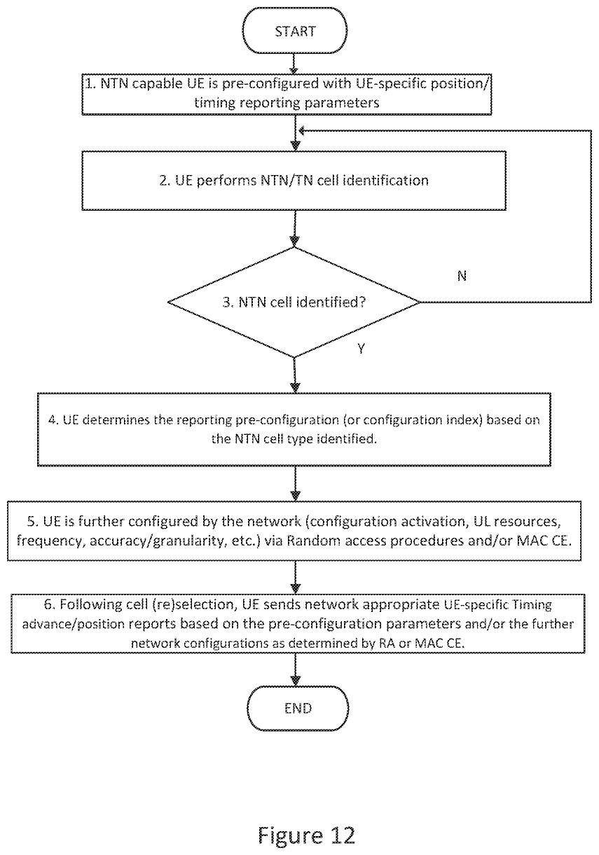

Furthermore, this process is illustrated in FIG. 12, highlighted by the following steps:

Step 1. An NTN-capable UE is pre-configured with UE-specific position/UE-specific TA reporting parameters as well as TA compensation parameters specific for an NTN cell (cell type such as LEO, MEO, or NTN cell group, constellation, etc.). These parameters may include UL grant/resource allocation for potential reports, when to report (e.g., time of report transmission), thresholds associated with generation and transmission of UE reports, e.g., based on UE mobility, granularity/accuracy requirements for the reports, or periodicity (frequency) of UE-specific TA report (e.g., TA for UE to satellite) and position reporting. Note that pre-configuration of NTN operation parameters suggests a priori configuration into the USIM or ME (e.g., non over the air configuration by the manufacturer or the operator, OTA device management configuration, etc.)

Step 2. Based on the methods discussed herein, UE performs NTN/TN cell identification based on explicit or implicit identifying characteristics of the platform.

Step 3. UE determines an NTN cell and/or NTN cell type has been identified.

Step 4. For UE-specific TA reporting and position reporting, UE determines the reporting pre-configuration based on the NTN cell type identified. For each NTN cell type or furthermore NTN cell group based on, (PLMN ID, NR frequency, Tracking Area, RANAC, PCI, etc.). Other triggers for reporting, such as UE mobility may determine more/less frequency UE-specific reports. The NTN cell “common” (feeder link) initial TA values may also be determined based on the stored pre-configurations if e.g., UE location and satellite ephemeris is available.

Step 5. UE is further configured by the network via Random Access procedures and/or MAC CE (e.g., UE-specific reporting configuration/index activation, UL resources, frequency of reports, accuracy/granularity associated with the UE reports, etc.).

Step 6. Following cell (re)selection, UE sends network appropriate UE-specific Timing advance/position reports based on the pre-configuration parameters and/or the further network configurations as determined by RA or MAC CE.

### 5.2 Solutions for Problem Statement 2: NTN Cell Selection

Cell selection may be performed by one of two procedures described in TS 38.304 sec 5.2.3. First, is with no prior knowledge of which RF channels are NR or NTN frequencies. The second is cell selection by leveraging stored information. To address uniform received power across NTN cell coverage and mixed NTN/TN deployment scenarios, the TN cell selection procedures may be enhanced.

### 5.2.1 Enhancements to TS 38.304

### TS 38.304 5.2.3.1 Description

Cell selection may be performed by one of the following two procedures.

In the first procedure, initial NTN/TN cell selection may proceed with no prior knowledge of which RF channels are NR or NTN frequencies. The UE scans all RF channels in the NR bands according to its capabilities to find a suitable cell. On each frequency, the UE need only search for the strongest cell, except for operation with shared spectrum channel access where the UE may search for the next strongest cell(s). For NTN operations, where UE may search for the next strongest cell(s) determined by satellite ephemeris (and UE location), NTN platform type, and UTC time. Based on the platform obtained from the System Information, UE may select the cell prioritized based on platform type in conjunction with signal strength. Once a suitable cell is found, this cell may be selected.

In the second procedure, cell selection may proceed by leveraging stored information. This procedure requires stored information of NTN/TN frequencies and optionally also information on NTN/TN cell parameters from previously received measurement control information elements or from previously detected cells. Ephemeris and orbital parameters for NTN cells stored from previously detected cells per time of day relative to e.g., UTC accurate time (based on GNSS) and optionally location (relative UE location based on previous cell selections). Once the UE has found a suitable cell, the UE may select it. If no suitable cell is found, the initial cell selection procedure in a) may be started.

### 5.2.2 Further Examples

To aid in cell selection for NTN and mixed NTN/TN environments it is proposed that satellite ephemeris information and UE location information (derived from GNSS or other positioning methods including NTN cell-based) is used to help UEs perform measurements. Calculated/stored geographic UE position information, possibly coupled with SI broadcast information that includes cell radius/time, and RSRP/RSRQ measurements, can be considered for the UE to camp on an NTN cell. In turn, this could be stored and used by the UE for future (re)selections.

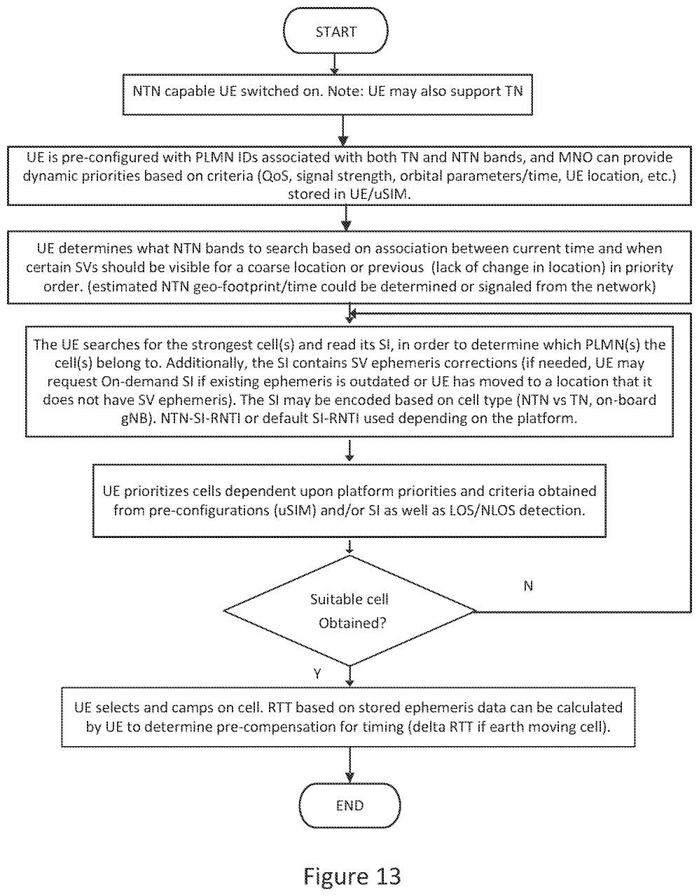

The process flow as shown in the FIG. 13 is designed to aid the UE in cell search and selection. From the ephemeris data, the UE can determine the estimated NTN cell geo-footprint in a given time. Alternatively, this coverage footprint could be signaled from the network, which is essentially determined by the satellite ephemeris creating a time domain heat map for NTN cells.

In one embodiment, the UE is pre-configured with PLMN IDs associated with both TN and NTN bands, and MNO can provide dynamic priorities based on criteria (signal strength, orbital parameters/time, UE location, etc.) stored in UE/uSIM. This may be coupled with frequency layer prioritization/selection. However, frequency layer prioritization as a standalone solution may have shortcomings due to the fast-moving nature of LEO SVs and TN/NTN deployed on the same bands.

Then, UE determines what NTN bands to search based on association between current time and when certain SVs should be visible for a coarse location or recent location calculation (lack of change in location) in priority order (estimated NTN geo-footprint/time could be determined or signaled from the network). This footprint can be stored in the UE or network and accessed several times for cell (re)selections given the SV may only be visible to the UE for several minutes, but then again visible in e.g., 90 min or more, depending on the orbital parameters of the satellite.

Once the information is known to the UE, The UE searches for the strongest cell(s) and read its SI, in order to determine which PLMN(s) the cell(s) belongs to. Additionally, the SI contains SV ephemeris corrections (if needed, UE may request On-demand SI if existing ephemeris is outdated, or UE has moved to a location that it does not have SV ephemeris).

In one embodiment, the SI may be encoded based on cell type and/or NTN type. For broadcast SI, if UE prefers or is only capable of one type of platform, it may only be able to decode the SI from a platform of priority/ranking, choice and/or capability (NTN vs TN, on-board gNB, or NTN type). For RMSI (e.g., SIB1), NTN-SI-RNTI or default SI-RNTI may be used depending on the platform for scrambling of the SI.

In addition to the existing cell selection criterion S, UE prioritizes cells dependent upon platform priorities and criteria obtained from pre-configurations (uSIM) and/or SI. Another input to these priorities may also include LOS/NLOS detection.

Based on this additional criterion, if a suitable cell is obtained, UE selects and camps on the cell. RTT based on stored ephemeris data can be calculated by UE to determine pre-compensation for timing. If the NTN cell is determined to be an earth-moving cell, this timing compensation could be a change in RTT over time.

### 5.3 Solutions for Problem Statement 3: NTN Cell Reselection

For mixed TN and NTN platform deployments, the priorities for selection of NTN (in various platforms, e.g., LEO, MEO) and TN are proposed. In NTN, there can be different requirements to operate in these cells, for example, timing and frequency compensation requirements. Therefore, it is better to prioritize the cell (re)selection based on the cell type for a given deployment, platform implementation, and MNO preferences.

It is also possible that frequency band is shared between TN and NTN in which case the RRM procedure may be impacted for both TN and NTN UEs. For example, suppose TN vs NTN indication is provided in SIB1. This would mean simply from acquisition of SSB (e.g., MIB), UE would not be able to decide the cell type. Further UE would need to acquire SIB1 and find out. Now if there are TN and NTN cells sharing the NR band(s), NR UEs will frequently detect NTN cells and NTN UEs will frequently detect NR cells. This is additional power consumption for UEs due to unnecessary measurement of wrong cells.

### 5.3.1 Satellite Ephemeris Usage

Updated ephemeris data for LEO/MEO, orbit, location of SV, at a given time of day, could be stored/pre-configured on device with only correction/clock corrections/small sets of data to be sent in SI. Additionally, in multi-beam scenarios, the UE could be able to check against already stored ephemeris for that cell.

In some embodiments, some “seed” data for the SV(s) orbits in time could be provisioned to the UE, which would give the UE enough information to track SVs over time and potentially over several orbits.

Since NTN cells travel in predictable orbits over time, frequent SI updates may not be necessary, only some correction data. This could be either broadcasted from the SV or the gNB, or another entity (similar to RTK correction base stations).

In these scenarios, the UE learns and then stores a table of the SV ID, ephemeris, and TOD.

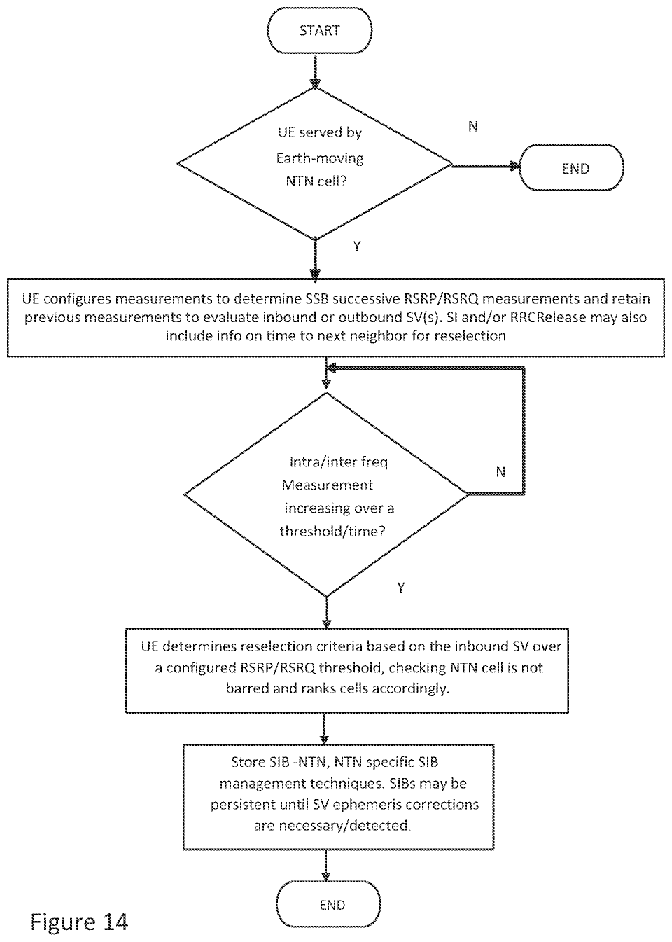

The System Information for Earth-moving (e.g., LEO/MEO) cells may be significantly different than the currently defined SI for TN cells. There are some SI elements that could be enhanced/added to assist the UE in making cell reselections more efficient, based on platform priorities. For example, the process flow and associated criteria of the example of FIG. 14 could be utilized for LEO/MEO NTN platforms.

In the preferred embodiment, the UE determines the network platform and specifically the NTN platform type of the cell. This may be based on broadcast/signaled system information, e.g., determined by calculating RTT, presence of timing offset, NTN SIB, and correlating that information with an NTN platform type.

### 5.3.2 Measurement Methods and Rules

The UE may be configured for measurements to determine SSB successive RSRP/RSRQ measurements and retain previous measurements to evaluate inbound or outbound SV(s). SI and/or RRCRelease may also include info on time to next neighbor for reselection. If the UE determines that the inter-frequency measurements or intra-frequency measurements are increasing above a pre-configured threshold (e.g., delta RX signal strength/time), the UE may read that cell's system information and store the associated NTN-SIB, leveraging NTN specific SIB management techniques. This assumes that the cell is not barred. If the UE determines that the inter-frequency measurements or intra-frequency measurements are not above a pre-configured threshold (e.g., delta RX signal strength/time), the triggers for reselection are not considered satisfied.

### 5.3.3 Enhancements to 38.304

### 5.2.4.1 Reselection Priorities Handling

Absolute priorities of different NR frequencies or inter-RAT frequencies may be provided to the UE in the system information, in the RRCRelease message, or by inheriting from another RAT at inter-RAT cell (re)selection. In the case of system information, an NR frequency or inter-RAT frequency may be listed without providing a priority (e.g., the field cellReselectionPriority is absent for that frequency). If priorities are provided in dedicated signalling, the UE may ignore all the priorities provided in system information. If UE is in camped on any cell state, UE may only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE may consider the current frequency to be the lowest priority frequency (e.g., lower than any of the network configured values). In the case ofNTN-capable UEs, NTN-specific priorities for reselection may be provided to the UE in system information, in the RRCRelease message, or by inheriting from another RAT at inter-RAT cell (re)selection.

The UE may only perform cell reselection evaluation for NR frequencies and inter-RAT frequencies that are given in system information and for which the UE has a priority provided.

The UE may also have deprioritization procedures as per 38.304. In case UE receives RRCRelease with deprioritisationReq, UE may consider current frequency and stored frequencies due to the previously received RRCRelease with deprioritisationReq or all the frequencies of NR to be the lowest priority frequency.

With regards to timers, the UE in RRC_IDLE state may inherit the priorities provided by dedicated signaling and the remaining validity time (e.g., T320 in NR and E-UTRA), if configured, at inter-RAT cell (re)selection. In the case of UEs supporting NTN earth-moving cells, these timers may be associated with the visibility of an SV within a given/configured elevation angle and time based on satellite ephemeris.

### 5.2.4.2 Measurement Rules for Cell Re-Selection

The following rules may be used by the UE to limit needed measurements. First, if the TN serving cell fulfils Srxlev>SIntraSearchP and Squal>SlntraSearchQ, the UE may choose not to perform intra-frequency measurements. Otherwise, the UE may perform intra-frequency measurements.

Second, if the NTN serving cell fulfils Srxlev>SintraSearchP and Squal>SintraSearchQ, the UE may choose to evaluate the type of NTN platform and coverage area/time, associated satellite ephemeris data, location to determine when to perform intra-frequency measurements. Otherwise, the UE may perform intra-frequency measurements.

The UE may apply rules for NR inter-frequencies and inter-RAT frequencies which are indicated in system information and for which the UE has priority. For example, if the UE supports relaxed measurement and relaxedMeasurement is present in SIB2, the UE may further relax the needed measurements. Extended/enhanced relaxedMeasurement may be useful for the network to configure for geo-stationary (GEO) NTN platform deployments, where the NTN cell footprint may be quite large.

### 5.2.4.3 Mobility States of a UE

### 5.2.4.3.0 Introduction

The UE mobility state is determined if the parameters (TCRmax, NCR_H, NCR_M and TCRmaxHyst) are broadcasted in system information for the serving cell.

State detection criteria may include normal-mobility state criteria, e.g., whether
a number of cell reselections during a time period TCRmax is less than NCR_M.

Medium-mobility state criteria may include whether a number of cell reselections during a time period TCRmax is greater than or equal to NCR_M but less than or equal to NCR_H.

High-mobility state criteria may include whether a number of cell reselections during a time period TCRmax is greater than NCR_H.

The UE may not necessarily consider consecutive reselections where a cell is reselected again right after one reselection for mobility state detection criteria.

For state transitions, if the criteria for High-mobility state is detected the UE may enter a high-mobility state. Otherwise, if the criteria for a medium-mobility state is detected, the UE may enter the medium-mobility state.

If criteria for either medium- or high-mobility state are not detected during time period TCRmaxHyst, the UE may enter a normal-mobility state.

If the UE is in High- or Medium-mobility state, the UE may apply the speed dependent scaling rules as described in clause 5.2.4.3.1.

For NTN environments, if the UE is camped on NTN non-geostationary cells, NTN-moving state criteria may include that if number of cell reselections during time period TCRmax_ntn is greater than NCR_H_ntn. For state transitions, the NTN UE may, if the criteria for NTN-moving state is detected, enter NTN-moving-cell state. Else it may enter Normal, Medium, or High-mobility state. Alternatively, mobility state may be redefined specifically for NTN platform, e.g., NTN-GEO-mobility, NTN-LEO-mobility, NTN-MEO-mobility, NTN-HAPS-mobility.

### 5.2.4.4 Cells with Cell Reservations, Access Restrictions or Unsuitable for Normal Camping

For NTN operations, cell barred, cell reserved, etc. may also have the same functionality. Depending on implementation, the NTN cell may enter one of these states dependent upon factors such as SV outages, or taken out of service.

For the highest ranked cell (including serving cell) according to cell reselection criteria specified in clause 5.2.4.6, for the best cell according to absolute priority reselection criteria specified in clause 5.2.4.5, the UE may check if the access is restricted according to the rules in clause 5.3.1.

If that cell and other cells have to be excluded from the candidate list, as stated in clause 5.3.1, the UE may not consider these as candidates for cell reselection. This limitation may be removed when the highest ranked cell changes.

If the highest ranked cell or best cell according to absolute priority reselection rules is an intra-frequency or inter-frequency cell which is not suitable due to one or more of the following reasons:
this cell belongs to a PLMN which is not indicated as being equivalent to the registered PLMN, or
this cell is a CAG cell that belongs to a PLMN which is equivalent to the registered PLMN but with no CAG ID that is present in the UE's allowed CAG list being broadcasted, or
this cell is not a CAG cell and the CAG-only indication in the UE is set, or
this cell is a SNPN cell that belongs to a SNPN that is not equal to the registered or selected SNPN of the UE in SNPN access mode,
   the UE may not consider this cell and, for operation in licensed spectrum, other cells on the same frequency as candidates for reselection for a maximum of 300 seconds.

### 5.2.4.5 NR Inter-Frequency and Inter-RAT Cell Reselection Criteria

If threshServingLowQ is broadcast in system information and more than 1 second has elapsed since the UE camped on the current serving cell, cell reselection to a cell on a higher priority NR frequency or inter-RAT frequency than the serving frequency may be performed if a cell of a higher priority NR or EUTRAN RAT/frequency fulfils Squal>Thresh_{X, HighQ} during a time interval TreselectionRAT.

In the case of UE camped on an NTN serving cell, the cell of higher priority should also be associated with an NTN platform with Treselection(ntn) associated with satellite ephemeris.

Otherwise, cell reselection to a cell on a higher priority NR frequency or inter-RAT frequency than the serving frequency may be performed if: a cell of a higher priority RAT/frequency fulfils Srxlev>ThreshX, HighP during a time interval TreselectionRAT; and more than 1 second has elapsed since the UE camped on the current serving cell.

Cell reselection to a cell on an equal priority NR frequency may be based on ranking for intra-frequency cell reselection as defined in clause 5.2.4.6.

If threshServingLowQ is broadcast in system information and more than 1 second has elapsed since the UE camped on the current serving cell, cell reselection to a cell on a lower priority NR frequency or inter-RAT frequency than the serving frequency may be performed if the serving cell fulfils Squal<Thresh_{Serving, LowQ} and a cell of a lower priority NR or E-UTRAN RAT/frequency fulfils Squal>Thresh_{X, LowQ} during a time interval Treselection_{RAT}.

In the case of UE camped on an NTN serving cell, the cell of lower priority should also be associated with an NTN platform with Treselection(ntn) associated with satellite ephemeris.

Otherwise, cell reselection to a cell on a lower priority NR frequency or inter-RAT frequency than the serving frequency may be performed if the serving cell fulfils Srxlev<Thresh_{Serving, LowP} and a cell of a lower priority RAT/frequency fulfils Srxlev>Thresh_{X, LowP} during a time interval Treselection_{RAT}; and more than 1 second has elapsed since the UE camped on the current serving cell.

In the case of UE camped on an NTN serving cell, the cell of lower priority should also be associated with an NTN platform with Treselection(ntn) associated with satellite ephemeris.

Cell reselection to a higher priority RAT/frequency may take precedence over a lower priority RAT/frequency if multiple cells of different priorities fulfil the cell reselection criteria.

If more than one cell meets the criteria, the UE may reselect a cell as follows:
If the highest-priority frequency is an NR frequency, the highest ranked cell among the cells on the highest priority frequency(ies) meeting the criteria according to clause 5.2.4.6;
If the highest-priority frequency is from another RAT, the strongest cell among the cells on the highest priority frequency(ies) meeting the criteria of that RAT.

### 5.2.4.6 Intra-Frequency and Equal Priority Inter-Frequency Cell Reselection Criteria

The cell-ranking criterion Rₛ for serving cell and Rₙ for neighboring cells is defined by:

Rₛ=Q_{meas,s}+Q_{hyst}−QOffSetₜₑₘₚ

Rₙ=Q_{meas,n}−Qoffset−Qoffsetₜₑₘₚ

where:

| Qₘₑₐₛ | RSRP measurement quantity used in cell |
|---|---|
| | reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in TS |
| | 38.331. |

The UE may perform ranking of all cells that fulfil the cell selection criterion S, which is defined in 5.2.3.2.

The cells may be ranked according to the R criteria by deriving Q_{meas,n} and Q_{meas,s} and calculating the R values using averaged RSRP results.

In NTN, for moving cells, the calculation of R values using averaged RSRP results may not be sufficient. This calculation should be a result over time and determine if the NTN cell is moving further or closer to the UE. This could be important for UEs that do not support accurate positioning to determine UE-NTN cell relative position.

The cell-ranking criterion R_{sNTN} for serving cell and R_{nNTN} for neighboring cells is defined by:

R_{sNTN}=Q_{measNTN,s}+Q_{hyst}−Qoffsetₜₑₘₚ

R_{nNTN}=Q_{measNTN,n}−Qoffset−Qoffsetₜₑₘₚ

where:

| Q_{measNTN} | RSRP measurement gradient used in cell |
|---|---|
| | reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in TS |
| | 38.331. |

The NTN UE may perform ranking of all cells that fulfil the cell selection criterion S, which is defined in 5.2.3.2.

The cells may be ranked according to the R criteria by deriving Q_{measNTN,n} and Q_{measNTN,s} and calculating the R values using RSRP results to determine increasing or decreasing delta over time. This only applies for gNBs coupled with earth-moving (non-geostationary) NTN cells.

If rangeToBestCell is not configured, the UE may perform cell reselection to the highest ranked cell. If this cell is found to be not suitable, the UE may behave according to clause 5.2.4.4.

If rangeToBestCell is configured, then the UE may perform cell reselection to the cell with the highest number of beams above the threshold (e.g., absThreshSS-BlocksConsolidation) among the cells whose R value is within rangeToBestCell of the R value of the highest ranked cell. If there are multiple such cells, the UE may perform cell reselection to the highest ranked cell among them. If this cell is found to be unsuitable, the UE may behave according to clause 5.2.4.4.

In all cases, the UE may reselect the new cell, only if the following conditions are met: the new cell is better than the serving cell according to the cell reselection criteria during a time interval TreselectionRAT; and more than 1 second has elapsed since the UE camped on the current serving cell.

If rangeToBestCell is configured but absThreshSS-BlocksConsolidation is not configured on an NR frequency, the UE considers that there is one beam above the threshold for each cell on that frequency.

### 5.2.4.7.0 General Reselection Parameters

Separate NTNparameters are defined for e.g., Thresh and Treselection.

Cell reselection parameters may be broadcast in system information and are read from the serving cell as follows, as illustrated in Table 5 of Appendix 1.

### 5.2.4.7.1 Speed Dependent Reselection Parameters

Speed dependent reselection parameters may be broadcast in system information and are read from the serving cell as illustrated in Table 6 of Appendix 1.

### 5.2.4.8 Inter-RAT Cell Reselection in RRC_INACTIVE State (No Change Required)

For UE in the RRC_INACTIVE state, upon cell reselection to another RAT, UE transitions from RRC_INACTIVE to RRC_IDLE and performs actions as specified in TS 38.331.

### 5.2.4.9 Relaxed Measurement Rules

When the UE is required to perform measurements of intra-frequency or NR inter-frequencies or inter-RAT frequency cells according to the measurement rules in clause 5.2.4.2: See to Exhibit B of Appendix 2.

cellEdgeEvaluation may not be configured for NTN platforms. Alternatively, cellEdgeEvaluation is determined by UE location and satellite ephemeris.

MobilityStateParameters For NTN earth moving cells, HO and reselections will happen quickly. Since this parameter is based on TN cells, there should be an equivalent IE for NTN earth moving cells. Otherwise, the UE will always be in a highly mobile state.

The relaxed measurements and no measurement are not applicable for frequencies that are included in VarMeasldleConfig, if configured and for which the UE supports dual connectivity or carrier aggregation between those frequencies and the frequency of the current serving cell.

### 5.4 Solutions for Problem Statement 4: Selection for 2-Step RACH

Based on the nearly uniform RSRP measurements across an NTN cell coverage footprint per FIG. 3, there is the need for additional criteria for 2-step RACH selection.

If ephemeris data is available at the UE and/or at gNB for serving satellite, this information could be used to determine and select 2-step RA versus 4-step RA (cell-center vs cell edge). This may also require the absolute geographic UE location or relative UE location. Relative location (based on RTT/TDOA, etc.) in this case could be distance from the satellite.

Other possible criteria: change in RSRP measurements (over time) from an NTN cell, strictly from ephemeris+time/UE location, relative UE distance from the NTN cell based on known ephemeris data, or elevation angle of the NTN cell.

The configuration of RACH mechanism and resources may be based on UE capabilities (e.g., whether or not the UE location is known, mobility, UE device type.) For example, if UE location is known, 2-step RA could be prioritized because UE may be able to estimate RTT. If no location is known or UE is not capable of determining its own accurate location or outdated UE location, 4-step RA could be selected and gNB would then be able to estimate RTT and return appropriate TA/timer configurations.

Some of this criterion could be also used for CHO (Conditional Hand Over).

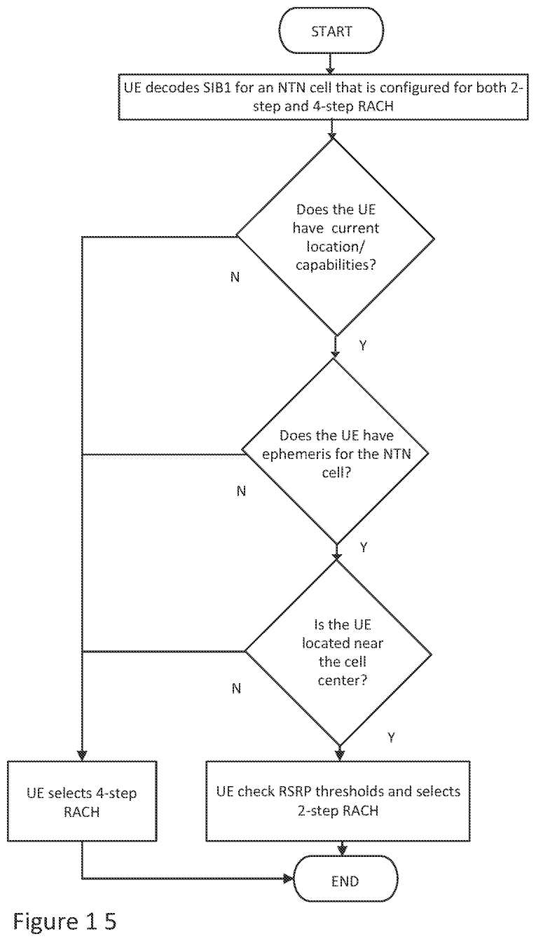

For these enhanced procedures, the process flow is shown in the FIG. 15. Note that some of the prerequisite process flow is omitted and known in the art, e.g., UE will need to decode the SS block, MIB, etc. before decoding SIB1. Once SIB1 is decoded by the UE, the UE will be able to determine if both 2-step and 4-step RACH are configured for that particular NTN cell.

In the situation where both 2-step and 4-step RACH are configured, the UE should determine the following three items. First is whether the UE has recent and accurate location information. Second is valid and up-to-date satellite ephemeris information for the particular NTN cell. Third is whether the UE is located at or near the cell center. UE location near the cell center may be determined by elevation angle of the cell, RTT, relative location to the NTN cell, etc. Further, legacy RSRP/RSRQ criteria/thresholds may also be used, e.g., in checking to ensure that the NTN cell is valid (no outage situation).

If these factors can be satisfied, the UE may select the 2-step RACH procedure. Fallback to 4-step RACH is possible if the 2-step RACH procedure is not successful.

In an alternative embodiment, LOS/NLOS identification could be also used as another input to select 2-step RACH versus 4-step RACH. In the event, LOS is identified by the UE, the UE may select 2-step RACH. In the event, NLOS is identified by the UE, the UE may select 4-step RACH.

### 5.4.1 Specification Enhancements for RACH Selection

The criteria for selection of 2-step RACH versus 4-step RACH from TS 38.321 section 5.1.1 is solely based on RSRP thresholds, which is not sufficient criteria for NTN. It is proposed that enhancements such as those shown in Exhibit C of Appendix 2 are made to TS 38.321. It may also be considered to modify one or more of the corresponding RRC field descriptions in 38.331. For example, RACH-ConfigCommonTwoStepRA->msgA-RSRP-Threshold

### 5.5 Solutions for Problem Statement 5: ANR Enhancements for NTN

Enhancements to the existing ANR techniques and procedures are proposed, including methods to update and manage the NCRT, with consideration for NTN platform characteristics.

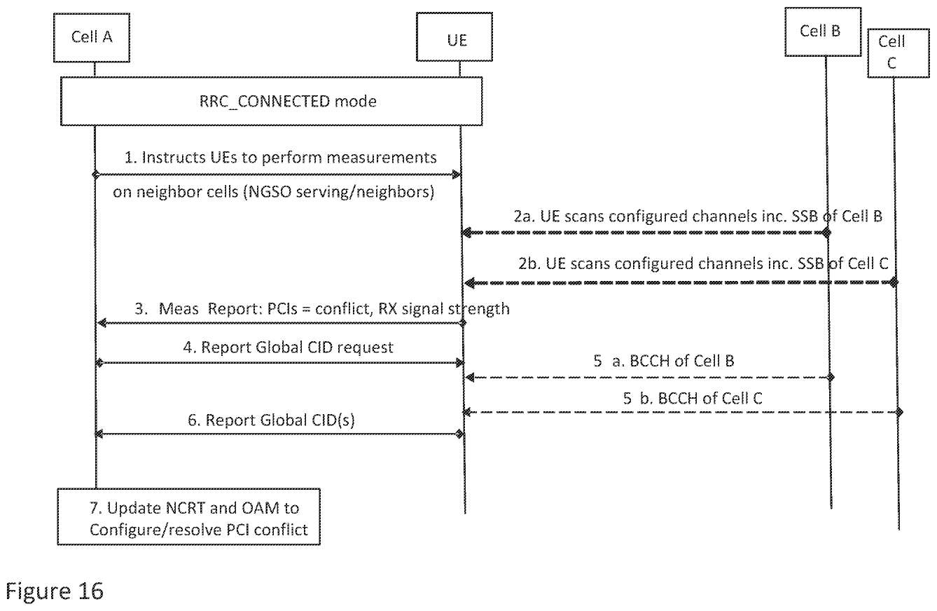

FIG. 16 illustrates a potential procedure to update and manage the NCRT, detect PCI conflicts such that OAM network elements may be able to resolve and update PCIs dynamically and/or change the PCI over time/earth-fixed geographic areas.

FIG. 16 depicts an example where the NTN NG-RAN node serving cell A and/or UE configured for NTN has an ANR function.

In step 1 o FIG. 16, in RRC_CONNECTED, the NTN cell/gNB, instructs each NTN-capable UE to perform measurements on neighbor cells. The NTN node may use different policies for instructing the UEs to do measurements, and when to report them to the NTN node. This specific measurement procedure would be specified in RRC.

In step 2, the UE scans all configured channels and decodes the SSBs of NTN and TN cells (Cell B and Cell C and Cell n).

In step 3, the UE sends a measurement report regarding cell B and cell C. This report contains Cell B's PCI, but not its NR Cell Global Identifier (NCGI)/E-UTRAN Cell Global Identifier (ECGI). The report contains the associated RSRP/RSRQ of each cell and potentially the indication of PCI conflicts. The PCI conflict may also be identified by the ANR function of the gNB.

In step 4, when the NTN node receives a UE measurement report containing the PCI(s), the NTN node may instruct the UE with a Report Global CID Request, using the newly discovered PCI as parameter, to read all the broadcast NCGI(s)/ECGI(s), TAC(s), RANAC(s), PLMN ID(s) and, for neighbor NR cells, NR frequency band(s). To do so, the NTN node may need to schedule appropriate idle periods to allow the UE to read the NCGI from the broadcast channel of the detected neighbor cell.

In step 5, the UE has found out the new cell's NCGI(s) by UE reading all the broadcast NCGI(s) by decoding the BCCH.

In step 6, the UE reports to the serving cell NTN node, the global CID(s). In addition, the UE reports all the tracking area code(s), RANAC(s), PLMN IDs and, for neighbor NR cells, NR frequency band(s), that have been read by the UE.

In step 7, the NTN node decides to add this neighbor relation table (which for NTN cells can include location, UTC time and other NTN platform characteristics), and can use PCI and NCGI(s) to: lookup a transport layer address to the new cell; update the Neighbor Cell Relation List; if needed, setup a new Xn interface towards this NTN cell/gNB; and if needed, OAM may be configured to resolve the identified PCI conflicts and cell(s) may be reconfigured with a new, temporary, or alternate PCI.

Similarly, as the ANR procedures should be enhanced for NTN configurations, also the NCRT should also be enhanced with the unique attributes of NGSO earth-moving NTN cells. FIG. 7 is taken from TS 38.300 and depicts how the ANR interaction and NCRT is updated.

Based on this interaction, the NCRT in the case of NTN, can be envisioned to be time based as the orbits of NGSO NTN cells are generally in a predictable orbit. Thereby, multiple NCRT tables may be managed by the OAM and gNB for given times of day or a single NCRT may have entries with a validity time/timer. See Table 7 of Appendix 1 for an example of NCRT with time aspects. In these cases, gNB could have the ability to exclude some neighbors. This may be based on the satellite ephemeris of the serving NTN cell and neighbors.

Additionally, OAM may configure some NTN or TN cells with an alternate, temporary PCI only in certain geographic areas/times that are known to produce PCI conflicts based on ANR/SON procedures, due to the orbital characteristics of an NTN cell.

### 5.6 Solutions for Problem Statement 6: Satellite Ephemeris Management

Based on the characteristics of the NTN platform and to reduce the amount of overhead in signaling system information and potentially satellite ephemeris corrections/data, the traditional TN management of SIBs should be enhanced. Exhibit D of Appendix 2 shows example enhancements to TS 38.331 as a baseline.

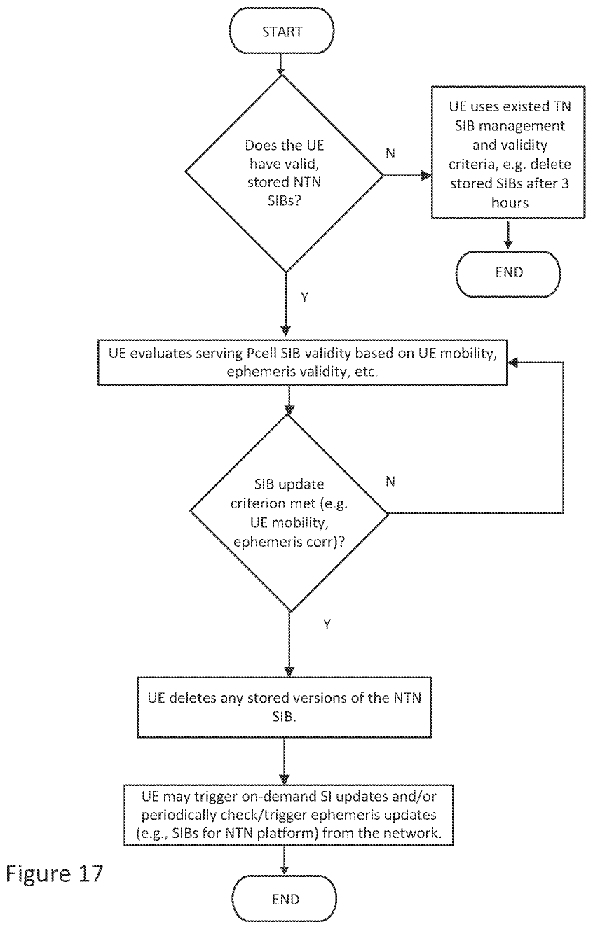

Enhancements to NTN SIB storage can be considered in process flow illustrated in FIG. 17 for NTN SIB management. Note that SIB and ephemeris data management may be a function of the UE and/or the network. These enhances may include consideration for factors such as: consideration for variations of the NTN platforms configured for the UE/gNB. For example, non-geostationary satellites may require the UE to invalidate/delete SIB data (some or all of the ephemeris data) more frequently than geostationary satellites; consideration for UE mobility state; consideration for periodicity of earth revolutions for earth moving NTN platforms; and consideration of frequency of ephemeris corrections/updates.

Consideration may also be made for for indexing ephemeris data for satellites or grouping of one or more constellations, such as indications of corrections and/or ephemeris update(s) and availability identified by an index or several indices in System Information. The ephemeris data may be grouped into serving cell versus neighbor cells. The granularity of the ephemeris data can also be further distinguished between serving cell, which may require higher granularity, and neighbor cell(s), which may only require lower granularity. This may enable more neighbor NTN cell ephemeris data to be sent via SI or stored on the device/uSIM due to size constraints and latency with potentially significant amounts of data.

Ephemeris data may be sent to the UE from the network or stored on the device in one or more levels of granularity depending on factors such as: serving and neighbor cells; time or distance associated with NTN cell orbit/constellation; NTN cell orbit type (e.g., LEO, MEO, GEO); type of device (e.g., REDCAP, IoT/MTC); UE mobility (stationary or semi-stationary); and UE capabilities.

In idle mode, the scheduled NTN SIBs would be in initial BWP, but due to the large size of the ephemeris content, alternative DL BWP could be scheduled. Potential use of other existing management protocols (e.g., OMA Device Management) for provisioning and management of satellite ephemeris. Satellite ephemeris updates and corrections could be either exclusively via System Information (SIB) updates or partially via SIB updates from serving NTN cell or neighbor cell(s), or external to System Information updates.

### 5. 6 Solutions for Problem Statement 7: SMTC Measurement Gaps for NTN

### Method 1:

To address the propagation delay difference between two NTN cells (one serving, one or more neighbor cells), the SMTC measurement gap configuration must consider modification to the SSB/CSI-RS measurement window such that UE are able to perform measurements on the configured reference signals.

We propose methods to enable SMTC measurement gap configurations for NTN-enabled UE, in the presence of one or more NTN cells and/or cell types. These solutions may be comprised one or more of the following steps. The network may have a priori knowledge of UE location, coarse or otherwise, as well as the location, orbits, trajectories (satellite ephemeris) of NTN cells. With this information, the UE may receive from the network, RRC measurement configuration message(s) inclusive of MG configuration(s).

These MG configurations include timing-related parameters relative to the serving cell NTN scenario type. Additionally, a plurality of additional MG configuration timing-related parameters relative to the propagation delay of neighbor NTN cells may be determined by one or more of the following sixth items. First is satellite ephemeris data for earth-fixed or moving NTN cells and UE location. Second is UE timing measurements (e.g., RTT). Third is a timing relationship between serving and neighbor NTN cells. Fourth is a priority related to cell (re)selection NTN type. Fifth is an NTN cell orbit type (e.g., LEO, MEO, GEO, HAPS). Note that the propagation delay may vary for the same NTN cell type depending on the altitude of the orbit(s). Sixth is a timer or time of day.

The MG configurations, associated timing offsets/adjustments, may be UE determined/calculated or network derived/aided or both. The configuration could be specific to a UE, multiple UE in same vicinity, or the same frequency with a larger and/or dynamic measurement window. In alternative embodiments, a UE, may receive from the network, a MG offset pre-configuration to adjust/compensate for timing relationships between serving cell propagation delay and neighbor cell(s) propagation delay, differentiated by NTN cell type (see exemplary IEs as follows for MeasGapConfig). The MG time-related parameters specific to NTN scenarios including, but not limited to, gap offset, MG length, MG repetition period, and MG timing advance can also be derived as shown below using TS 38.331 section 6.3.2 as a baseline:

### MeasGapConfig

The IE MeasGapConfig specifies the measurement gap configuration and controls setup/release of measurement gaps.

See 5.6 MeasGapConfig information element example of Appendix 1.

See also the 5.6 MeasGapConfig field descriptions of Appendix 1

These IEs may also be used in conjunction with existing SSB-MTC (SSB-MTC2) configured for given PCIs. The IE SSB-MTC is used to configure measurement timing configurations, i.e., timing occasions at which the UE measures SSBs.

### Method 2:

Given the high speed of satellites (LEO, MEO) and shorter sub-frame length (compared to terrestrial network), the uplink and downlink timing at the UE may need to be updated very frequently. In another embodiment, we propose that the UE can calculate the timing offset to be applied in its measurement gap of neighboring NTN cell(s). For example, based on the received information from the network (such as, Satellite ephemeris data for earth-fixed or moving NTN cells and UE location), timing relationship between serving and neighbor NTN cells, and etc.), and the UE's own measurement such as (DL timing measurements from different NTN cells and etc.), the UE calculates a timing offset to compensate the propagation delay difference between the serving NTN cell and neighboring NTN cell(s).

### Method 3

The methods described in here may be combined in a number of ways. For example,
the UE may receive the MG Configuration as described in Method 1 and apply the received gapOffsetNTN in its measurement gap in neighbor NTN cell(s). Then, as time goes (and propagation delay difference between serving and neighbor NTN cell changes), the UE may calculate a delta timing offset to the received gapOffsetNTN based on its calculation or measurement. The UE may continue to apply the delta timing offset+gapOffsetNTN in its measurement gap in neighbor NTN cell(s). The UE may also apply a delta timing offset rate over time, in other words, a change in gap offset over time as satellite orbit(s) propagation delay changes may be consistently changing over time (either held constant in the same constellation or vary in the case of a different constellation). The calculation can be the same as in Method 2. Later on, when the UE receives an updated MG Configuration as described in Method 1, it may apply the updated gapOffsetNTN in its measurement gap in neighbor NTN cell(s), and repeat other steps as required.

### Example Variations

A variety of solutions are described to address, inter alia, propagation delay and earth moving-cell characteristics of Non-terrestrial Network (NTN) platforms. Herein, the terms prioritization and selection are often used interchangeably.

### NTN Identification

Types of NTN platforms may be identified in a number of ways. User equipment may compute timing information indicative of the NTN nature of a platform and may further be able to classify the platform based on such timing information. For example, a UE may identify a range of timing offset relationship values associated with a particular network type associated with a specific satellite orbit determined by the extent of the offset value.

Additionally, or alternatively, NTN platforms may be identified via explicit signalling, e.g., either originating from NTN equipment or echoed by NTN equipment from a gNB elsewhere. For example, a broadcast message may be transmitted in part over a satellite communications link inclusive of a timing relationship offset value signaled to the UE via gNB.

NTN identification may be distributed in a number of sources. For example, a partial indication of an NTN platform in the Master Information Block broadcast from the gNB, along with implicit or explicit indication in System Information (e.g., SIB1) of a specific NTN type. Further, a UE may be preconfigured or dynamically configured with frequency band information or PLMN IDs to determine an association with a platform type or sub-type.

### NTN Prioritization

NTN platform types may be used when prioritizing potential communications pathways, e.g., as part of, or in addition to, considering preferences, such as UE capabilities (mobility or type of UE), service requirements, and Quality of Service. A network may provision UE with initial and subsequent updates of the platform priorities.

### NTN Cell Selection

A UE may obtain a suitable cell in the presence of a plurality of TN and NTN platform types, where a gNB operatively coupled or co-located with an NTN cell, by the UE scanning each frequency band based on its capabilities and for each frequency find the strongest cell, and search for the next strongest cell(s) if UE determines that the strongest cell is associated with NTN platform. That is, a UE may have a preference to use—or not use—an NTN cell when other cells are available.

Such searches may use persistent information stored at the UE via network delivery and/or pre-configured. The persistent information may include, for example, TN/NTN platform type and platform prioritization determined by control information, TN/NTN frequency prioritization, information on NTN/TN cell parameters from previously received measurement control information elements or from previously detected cells and ephemeris parameters for NTN cells stored from previously detected cells per time of day relative to e.g., UTC accurate time (based on e.g., GNSS) obtained via uSIM/SIM. Similarly, the persistent information may include UE location information, e.g., relative UE location based on previous cell selections, or other UE location information, coupled with UE received signal strength threshold, for example.

### NTN Cell Reselection

An NTN-capable UE may maintain a TN/NTN prioritization (ranking) list for cell reselection. Further NTN platform assistance data may be exchanged for NTN UEs and/or gNBs to rank cells for cell reselection in the presence of a plurality of network and platform types.

For example, a gNB may transmit NTN cell radius/time, TN/NTN measurement rules, ephemeris correction data or an ephemeris update indicator, and/or an indicator for the presence of NTN SIBs. Upon receipt of the system information from the gNB, the UE may identify the platform and identify platform type, and then check the validity of any existing SIBs (and possibly ephemeris) previously stored at the UE.

### Measurement Rules

Measurement rules, cell edge evaluation, and mobility state may be determined or influence by an NTN cell type and/or UE location. For example, if the cell platform type is an NTN earth-moving cell, the UE may configure measurements per NTN-specific measurement rules to determine SSB successive RSRP/RSRQ measurements and retain measurements to evaluate inbound or outbound NTN cell. The UE may also update and maintain an NTN cell coverage heat map for one or more location, e.g., per local time, which is coupled with R selection criterion, where R-selection is modified for NTN to determine increase/decrease in received power, for example.

### Priorities

The UE may be (pre)configured by the network or uSIM to maintain dynamic platform priorities, coupled with R selection criterion, to determine the selection of a particular cell. For example, the UE may receive NTN equipment ephemeris/correction data from the NTN equipment and/or from standalone ground base stations. This may be done in a fashion similar to RTK base stations transmitting corrections for GNSS.

Additionally, or alternatively, the UE may be provisioned UEs with dynamic platform priorities for given geographic locations and/or time of day.

### Two-Step Vs Four-Step R,ACH Selection

A UE may determine whether to use a of 2-step or 4-step Random Access Channel procedure based on NTN communications conditions. For example, the gNB of an NTN cell may broadcast system information such as scheduling, resources, and configuration (e.g., RA criterion and thresholds) information for both 2-step and 4-step RACH procedures. Upon receipt of the SI from the gNB, the UE may then evaluate whether it has recent and accurate location information, LOS/NLOS, valid and up-to-date satellite ephemeris information for the particular NTN cell and, located at or near the cell center. UE location near the cell center may be determined by elevation angle of the cell, RTT, relative location to the NTN cell, etc. Coupled with RSRP/RSRQ measurements or corresponding thresholds, for example, the UE may select a particular RACH procedure.

### NTN Automatic Neighbor Relations

UEs and gNB may cooperate in the management of NTN neighbor issues, such as PCI conflicts (PCI collisions and PCI confusion), for instance. For example, a gNB may teach NTN-capable UE to perform measurements on neighbor cells. Each UE then scans all configured channels, decodes the cell system information, and reports measurements and associated cell identifiers. If there is a PCI conflict, a UE may indicate this to the network. Additionally, or alternatively, the ANR function of the gNB may identify the conflict.

An OAM function may update a Neighbor Cell Relation Table (NCRT) of gNB by looking up a transport layer address to the new cell, updating a neighbor cell relation list, and evaluating visible time for earth-moving cells. If needed, the OAM may setup a new Xn interface towards this NTN cell/gNB. Further, if needed, the OAM/network may be configured to resolve the identified PCI conflicts, and cells may be reconfigured with a new or alternate PCI.

### Satellite Ephemeris Management

A UE may evaluate and determine the presence of satellite ephemeris data and/or SIBs associated with NTN platforms and corresponding satellite ephemeris data. The Satellite ephemeris data may be identified by one or more indices.

The UE may evaluate the validity of the stored SIB(s) associated with NTN platform and/or satellite ephemeris based on one or more of the following criteria: type of NTN platform associated with the SIB/ephemeris, periodicity of earth revolutions in the case of earth moving NTN platforms, and UE mobility. If valid, maintains the existing SIB/ephemeris. If invalid, the UE may delete the data and request an update of the SIB/ephemeris.

The network (e.g., gNB) may evaluate the validity of the broadcast SIB(s) associated with NTN platform and/or satellite ephemeris based on one or more of the following criteria: type of NTN platform associated with the SIB/ephemeris, periodicity of earth revolutions in the case earth moving NTN platforms, satellite corrections, identification, and availability. If valid, the network maintains the existing SIB (e.g., ephemeris data, index of ephemeris) for broadcast. If invalid, updates the SIB (e.g., ephemeris data, index of ephemeris) for broadcast.

Further, the satellite ephemeris data corrections and updates may be inclusive of System Information broadcasted by the gNB or managed wholly or in part by external management protocols and entities (e.g., OMA DM server).

It will be appreciated that the techniques described herein are often interoperable and combinable. For example, techniques describe for cell selection may be used also for reselection, and vice versa, and techniques for measurement, ephemeris, and neighbor management may be applied to either selection or reselection.

### Example Environments

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G.” 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

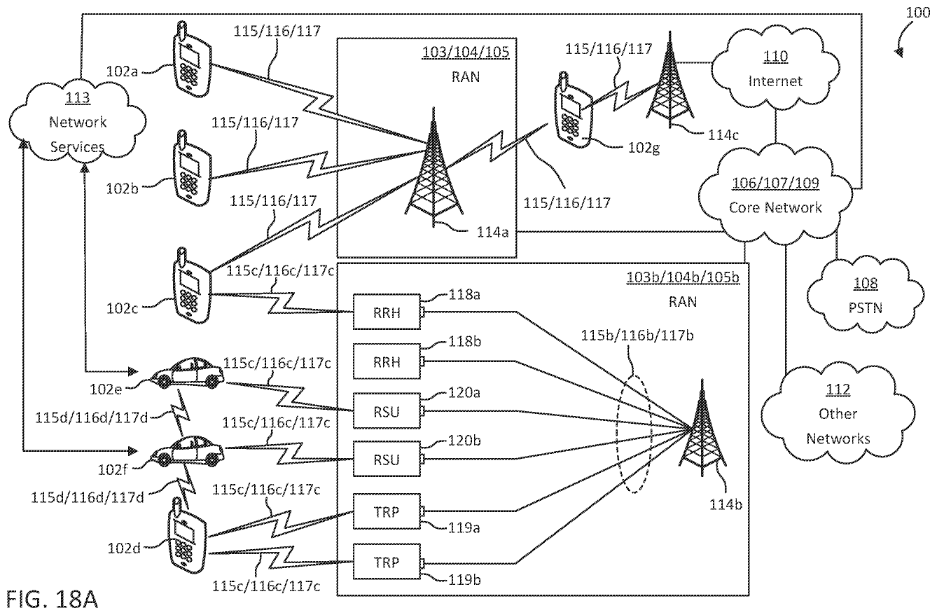

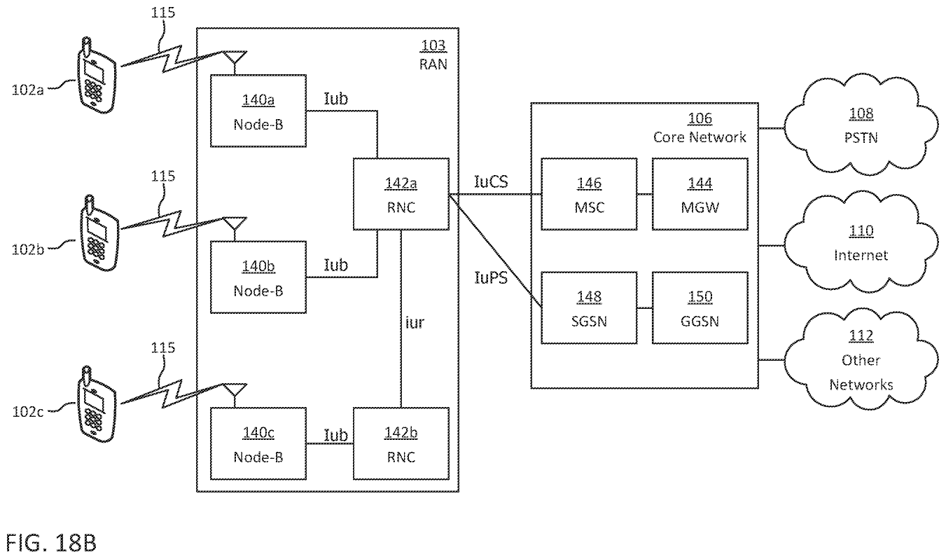

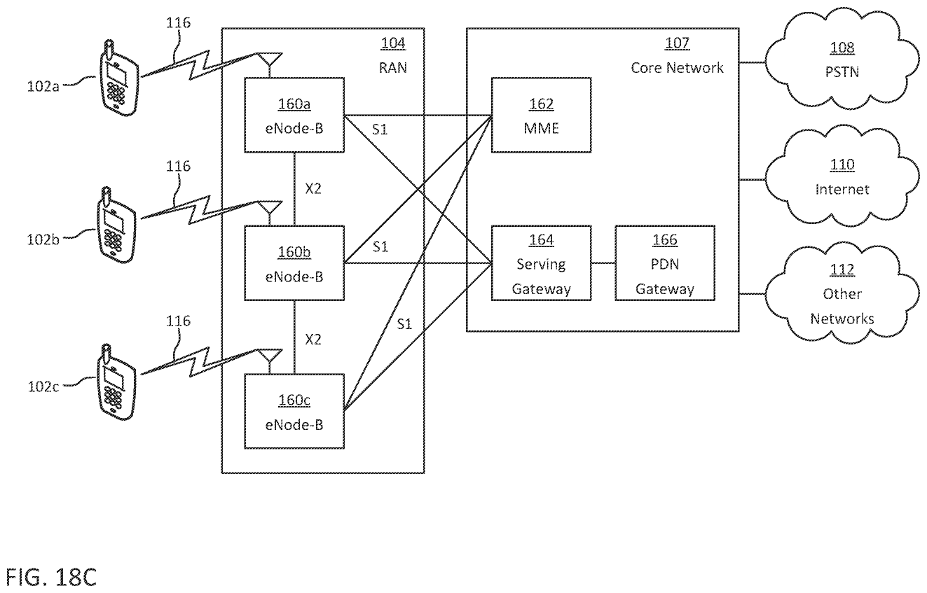

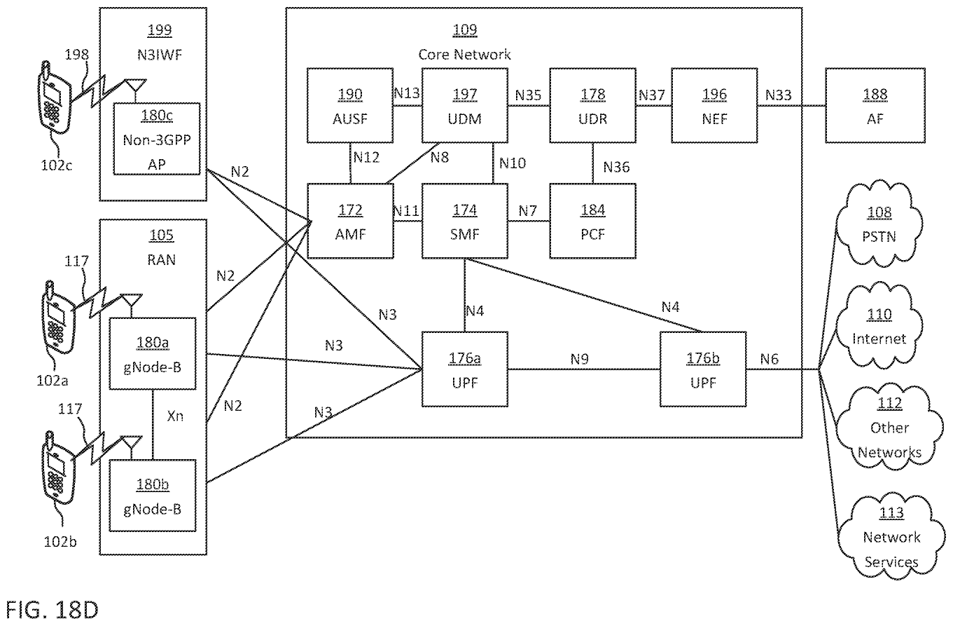

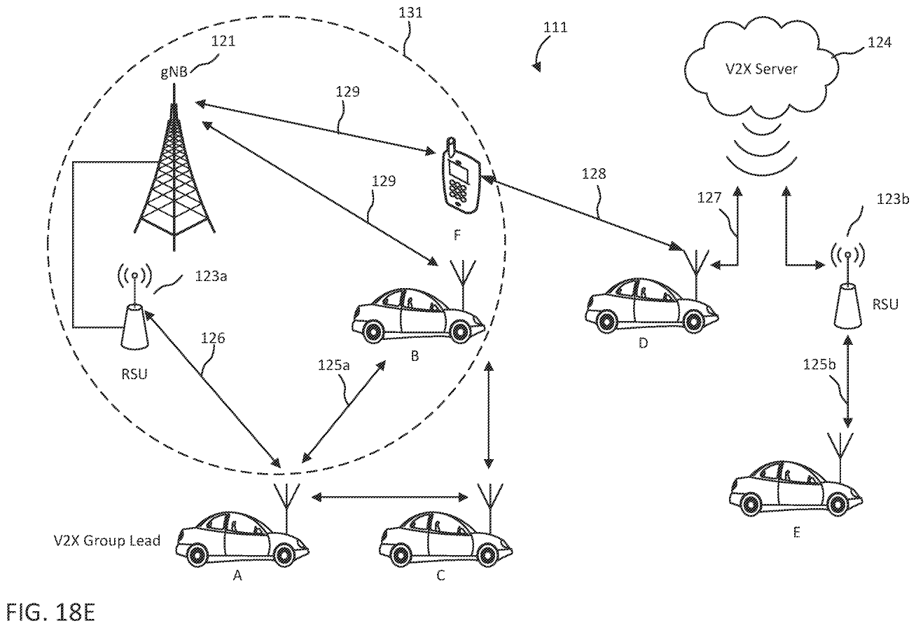

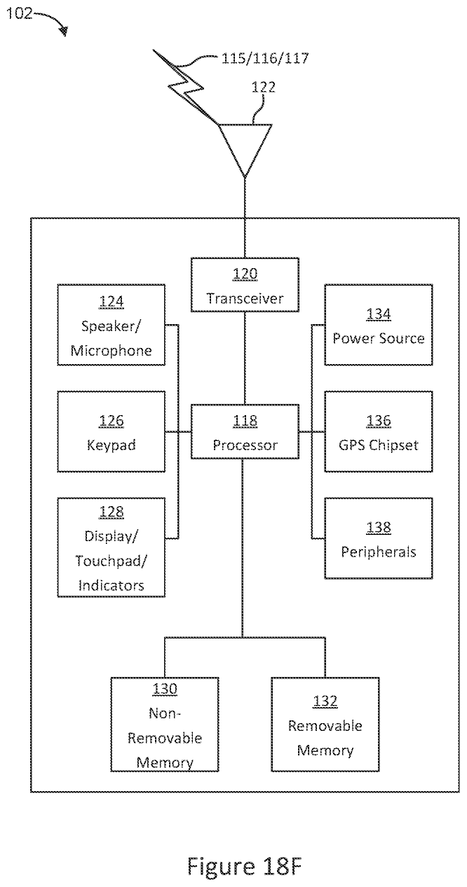

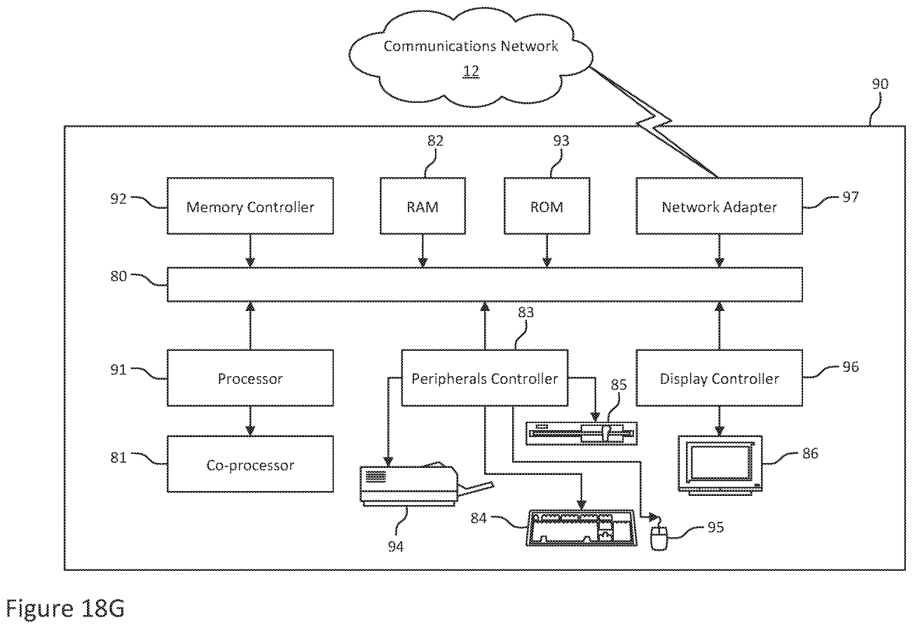

FIG. 18A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any number of WTRUs, base stations, networks, and/or network elements. Each of the WTRUs 102 may be any type of apparatus or device configured to operate and/or communicate in a wireless environment. In the example of FIG. 18A, each of the WTRUs 102 is depicted in FIGS. 18A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and abase station 114b. In the example of FIG. 18A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 18A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 18A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 18A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 18A may be configured to communicate with the base station 114a, which may employ a cellular-based radio technology, and with the base station 114c, which may employ an IEEE 802 radio technology.

Although not shown in FIG. 18A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 18B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 18B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 18B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 18B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 18C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 18C, the eNode-Bs 160a, 160b, and 160c may communicate with one another over an X2 interface.

The core network 107 shown in FIG. 18C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 18D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 18D, the gNode-Bs 180a and 180b may communicate with one another over an Xn interface, for example.

The core network 109 shown in FIG. 18D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 18G.

In the example of FIG. 18D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 18D shows that network functions directly connect to one another, however, it should be appreciated that they may communicate via routing agents such as a diameter routing agent or message buses.

In the example of FIG. 18D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 18D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 18D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect to network functions, so that network function can add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 18D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIG. 18A, FIG. 18C, FIG. 18D, and FIG. 18E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 18A-E are provided by way of example only, and it is understood that the subject matter disclosed and claimed herein may be embodied or implemented in any similar communication system, whether presently defined or defined in the future.

FIG. 18E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 18E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 18E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127.

WTRUs A, B, C, D, E, and F may communicate to another UE via a Vehicle-to-Person (V2P) interface 128.

FIG. 18F is a block diagram of an example apparatus or device WTRU 102 that may be configured for wireless communications and operations in accordance with the systems, methods, and apparatuses described herein, such as a WTRU 102 of FIGS. 18A-E. As shown in FIG. 18F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 18F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 18F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 18A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 18F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 18G is a block diagram of an exemplary computing system 90 in which one or more apparatuses of the communications networks illustrated in FIG. 18A, FIG. 18C, FIG. 18D and FIG. 18E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 18A-1E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

TABLE 1
APPENDIX 1
Acronyms

| | |
|---|---|
| ANR | Automatic Neighbor Relation |
| CHO | Conditional Hand Over |
| CORESET | Control Resource Set |
| C-RNTI | Cell Radio Network Temporary Identifier |
| DCI | Downlink Control Information |
| DL | Downlink |
| DMRS | Demodulation Reference Signal |
| ECGI | E-UTRAN Cell Global Identifier |
| GEO | Geostationary Earth Orbit |
| GNSS | Global Navigation Satellite System |
| GPS | Global Positioning System |
| HAPS | High Altitude Platform System |
| HO | Hand Over (or Hand Off) |
| IE | Information Element |
| IOT | Internet of Things |
| LEO | Low Earth Orbit |
| LOS | Line of Sight |
| LTE | Long Term Evolution |
| MAC | Medium Access Control |
| MAC-CE | Medium Access Control-Control Element |
| MCC | Mobile Country Code |
| MEO | Medium Earth Orbit |
| MG | Measurement Gap |
| MNC | Mobile Network Code |
| MNO | Mobile Network Operator |
| MTC | Machine Type Communication |
| NCRT | Neighbor Cell Relation Table |
| NGSO | Non-Geostationary Orbit |
| NLOS | Non-Line of Sight |
| NR | New Radio |
| NCGI | NR Cell Global Identifier |
| NTN | Non-Terrestrial Networks |
| OAM | Operations, Administration and Maintenance |
| PDCCH | Physical Downlink Control Channel |
| PSS | Primary synchronization signal |
| PUCCH | Physical uplink control channel |
| PUSCH | Physical uplink shared channel |
| RAN | Radio Access Network |
| REDCAP | Reduced Capability |
| RANAC | RAN-based Notification Area Code |
| RLF | Radio Link Failure |
| RNTI | Radio Network Temporary Identifier |
| RRC | Radio Resource Control |
| RSRP | Reference Signal Received Power |
| RSRQ | Reference Signal Received Quality |
| RTD | Round Trip Delay |
| SIB | System Information Block |
| SMTC | SSB Measurement Timing Configuration |
| SON | Self-Organizing Networks |
| SSB | Synchronization signal block |
| SSS | Secondary synchronization signal |
| SV | Satellite Vehicle |
| TA | Timing Advance |
| TN | Terrestrial Network |
| UE | User Equipment |
| UL | Uplink |
| Uu Interface | Radio interface between the mobile |
| | and the radio access network. |

TABLE 2
Types of NTN Platforms

| | NTN scenarios | | | | | |
|---|---|---|---|---|---|---|
| | A | B | C1 | C2 | D1 | D2 |
| | GEO | GEO | LEO | | LEO | |
| | transparent | regenerative | transparent | | regenerative | |
| | payload | payload | payload | | payload | |
| Satellite altitude | 35786 km | | 600 km | | | |
| Relative speed of | negligible | | 7.56 km per second | | | |
| Satellite with | | | | | | |
| respect to earth | | | | | | |
| Min elevation for | 10° for service link and 10° for feeder link | | | | | |
| both feeder and | | | | | | |
| service links | | | | | | |
| Typical Min/Max | 100 km/3500 km | | 50 km/1000 km | | | |
| NTN beam footprint | | | | | | |
| diameter (note 1) | | | | | | |
| Maximum | 541.46 ms | 270.73 ms | 25.77 | ms | 12.89 | ms |
| propagation delay | (Worst case) | | | | | |
| contribution to the | | | | | | |
| Round-Trip Delay | | | | | | |
| on the radio | | | | | | |
| interface between | | | | | | |
| the gNB and the UE | | | | | | |
| Minimum | 477.48 ms | 238.74 ms | 8 | ms | 4 | ms |
| propagation delay | | | | | | |
| contribution to the | | | | | | |
| Round-Trip Delay | | | | | | |
| on the radio | | | | | | |
| interface between | | | | | | |
| the gNB and the UE | | | | | | |
| Maximum Delay | Negligible | | Up to +/− | | Up to +/− | |
| variation as | | | 40 μs/sec | | 20 μs/sec | |
| seen by the UE | | | (Worst case) | | | |
| (note 2) | | | | | | |

(note 1):
The beam footprint diameter is indicative. The diameter depends on the orbit, earth latitude, antenna design, and radio resource management strategy in a given system.
(note 2):
The delay variation measures how fast the round-trip delay (function of UE-satellite-NTN gateway distance) varies over time when the satellite moves towards/away from the UE. It is expressed in μs/s and is negligible for GEO scenario
NOTE 3:
Speed of light used for delay calculation is 299792458 m/s.

TABLE 3
S-criterion parameters

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL frequency |
| | for this cell, Qrxlevmin is obtained from q-RxLevMinSUL, if present, in SIB1, |
| | SIB2 and SIB4, additionally, if Q_{rxlevminoffsetcellSUL} is present in SIB3 and |
| | SIB4 for the concerned cell, this cell specific offset is added to the corresponding |
| | Qrxlevmin to achieve the required minimum RX level in the concerned cell; |
| | else Qrxlevmin is obtained from q-RxLevMin in SIB1, SIB2 and SIB4, additionally, if |
| | Q_{rxlevminoffsetcell} is present in SIB3 and SIB4 for the concerned cell, this cell |
| | specific offset is added to the corresponding Qrxlevmin to achieve the required |
| | minimum RX level in the concerned cell. |
| Q_{qualmin} | Minimum required quality level in the cell (dB). Additionally, if Q_{qualminoffsetcell} is |
| | signalled for the concerned cell, this cell specific offset is added to achieve the |
| | required minimum quality level in the concerned cell. |
| Q_{rxlevminoffset} | Offset to the signalled Qᵣₓₗₑᵥₘᵢₙ taken into account in the Srxlev evaluation as a |
| | result of a periodic search for a higher priority PLMN while camped normally in a |
| | VPLMN, as specified in TS 23.122. |
| Q_{qualminoffset} | Offset to the signalled Q_{qualmin} taken into account in the Squal evaluation as a result |
| | of a periodic search for a higher priority PLMN while camped normally in a VPLMN, as |
| | specified in TS 23.122. |
| P_{compensation} | For FR1, if the UE supports the additionalPmax in the NR-NS-PmaxList, if present, in |
| | SIB1, SIB2 and SIB4: max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| P_{EMAX1}, | Maximum TX power level of a UE may use when transmitting on the uplink in the cell (dBm) |
| P_{EMAX2} | defined as P_{EMAX} in TS 38.101. If UE supports SUL frequency for this cell, P_{EMAX1} and P_{EMAX2} |
| | are obtained from the p-Max for SUL in SIB1 and NR-NS-PmaxList for SUL respectively in SIB1, |
| | SIB2 and SIB4 as specified in TS 38.331, else P_{EMAX1} and P_{EMAX2} are obtained from the p-Max |
| | and NR-NS-PmaxList respectively in SIB1, SIB2 and SIB4 for normal UL as specified in TS 38.331. |
| P_{PowerClass} | Maximum RF output power of the UE (dBm) according to the UE power class as defined in TS 38.101-1. |

TABLE 4
Essential Elements of Ephemeris

| | | |
|---|---|---|
| Orbital | \sqrt{a} | Square root of semi major axis (semi-major axis) |
| plane | e | Eccentricity (eccentricity) |
| parameters | i₀ | Inclination angle at reference time (inclination) |
| | Ω₀ | Longitude of ascending node of orbit plane (right |
| | | ascension of the ascending node) |
| | ω | Argument of perigee (argument of periapsis) |
| Satellite | M₀ | Mean anomaly at reference time (true anomaly and a |
| level | | reference point in time) |
| parameters | t₀ₑ | Ephemeris reference time (the epoch) |

TABLE 5
Cell Reselection Parameters

absThreshSS-BlocksConsolidation - This specifies the minimum threshold for beams which can be used for
selection of the highest ranked cells, if rangeToBestCell is configured, and for beams used for
derivation of cell measurement quantity. The parameter in SIB2 applies to the current serving frequency
and the parameter in SIB4 applies to the corresponding inter-frequency.
cellReselectionPriority -This specifies the absolute priority for NR frequency or E-UTRAN frequency.
cellReselectionSubPriority - This specifies the fractional priority value added to cellReselectionPriority
for NR frequency or E-UTRAN frequency.
combineRelaxedMeasCondition - This indicates when the UE needs to fulfil both low mobility criterion and
not-at-cell-edge criterion to determine whether to relax measurement requirements.
highPriorityMeasRelax - This indicates whether measurement on higher priority frequency is allowed to be
relaxed beyond T_{higher}_{_{—}}_{priority}_{_{—}}_{search} (see clause 4.2.2.7 in TS 38.133) or not (in case the relaxed
measurement criteria is fulfilled).
nrofSS-BlocksToAverage - This specifies the number of beams which can be used for selection of the highest
ranked cell, if rangeToBestCell is configured, and the number of beams used for derivation of cell
measurement quantity. The parameter in SIB2 applies to the current serving frequency and the parameter in
SIB4 applies to the corresponding inter-frequency. For NTN, the averaging of, e.g., earth-moving LEO/MEO
cells is less helpful for re-selection criteria than looking at the measurements as a series to determine
a trend, e.g., NTN cell moving further/closer to the UE geographical location.
Qoffset_{s, n -} This specifies the offset between the two cells.
Qoffset_{frequency -}Frequency specific offset for equal priority NR frequencies.
Q_{hyst -} This specifies the hysteresis value for ranking criteria.
Qoffset_{temp -} This specifies the additional offset to be used for cell selection and re-selection.
It is temporarily used in case the RRC Connection Establishment fails on the cell as specified in TS 38.331.
Q_{qualmin -} This specifies the minimum required quality level in the cell in dB.
Q_{rxlevmin -} This specifies the minimum required Rx level in the cell in dBm.
Q_{rxlevminoffsetcell -} This specifies the cell specific Rx level offset in dB to Qrxlevmin.
Q_{qualminoffsetcell -} This specifies the cell specific quality level offset in dB to Qqualmin.
rangeToBestCell - This specifies the R value range which the cells whose R value is within the range can be a
candidate for the highest ranked cell. It is configured in SIB2 and used for intra-frequency and equal priority
inter-frequency cell reselection and among the cells on the highest priority frequency(ies) for inter-frequency
cell reselection within NR.
S_{IntraSearchP -} This specifies the Srxlev threshold (in dB) for intra-frequency measurements.
S_{IntraSearchQ -} This specifies the Squal threshold (in dB) for intra-frequency measurements.
S_{nonIntraSearchP -} This specifies the Srxlev threshold (in dB) for NR inter-frequency and inter-RAT measurements.
S_{nonIntraSearchQ -} This specifies the Squal threshold (in dB) for NR inter-frequency and inter-RAT measurements.
S_{SearchDeltaP -} This specifies the threshold (in dB) on Srxlev variation for relaxed measurement.
S_{SearchThresholdP -} This specifies the Srxlev threshold (in dB) for relaxed measurement.
S_{SearchThresholdQ -} This specifies the Squal threshold (in dB) for relaxed measurement.
Treselection_{RAT -} This specifies the cell reselection timer value. For each target NR frequency
and for each RAT other than NR, a specific value for the cell reselection timer is defined, which is applicable
when evaluating reselection within NR or towards other RAT (e.g., Treselection_{RAT} for NR is Treselection_{NR},
for E-UTRAN Treselection_{EUTRA}). NOTE: Treselection_{RAT} is not broadcast in system information but used in
reselection rules by the UE for each RAT.
Treselection_{NR -} This specifies the cell reselection timer value Treselection_{RAT} for NR. The parameter
can be set per NR frequency as specified in TS 38.331.
Treselection_{NTN -} This specifies the cell reselection timer value Treselection_{RAT} for NTN. The parameter
can be set per NTN frequency as specified in TS 38.331.
Treselection_{EUTRA -} This specifies the cell reselection timer value Treselection_{RAT} for E-UTRAN.
Thresh_{X, HighP -} This specifies the Srxlev threshold (in dB) used by the UE when reselecting towards a higher
priority RAT/frequency than the current serving frequency. Each frequency of NR and E-UTRAN might have a specific threshold.
Thresh value ranges specific to NTN.
Thresh_{X, HighQ -} This specifies the Squal threshold (in dB) used by the UE when reselecting towards a higher
priority RAT/frequency than the current serving frequency. Each frequency of NR and E-UTRAN might have a specific threshold.
Thresh_{X, LowP -} This specifies the Srxlev threshold (in dB) used by the UE when reselecting towards a lower
priority RAT/frequency than the current serving frequency. Each frequency of NR and E-UTRAN might have a specific threshold.
Thresh_{X, LowQ -} This specifies the Squal threshold (in dB) used by the UE when reselecting towards a lower
priority RAT/frequency than the current serving frequency. Each frequency of NR and E-UTRAN might have a specific threshold.
Thresh_{Serving, LowP -} This specifies the Srxlev threshold (in dB) used by the UE on the serving cell when
reselecting towards a lower priority RAT/frequency.
Thresh_{Serving, LowQ -} This specifies the Squal threshold (in dB) used by the UE on the serving cell when
reselecting towards a lower priority RAT/frequency.
T_{SearchDeltaP -} This specifies the time period over which the Srxlev variation is evaluated for relaxed measurement.

TABLE 6
Speed Dependent Reselection Parameters

TCRmax - This specifies the duration for evaluating allowed amount of cell reselection(s).
NCR_M - This specifies the maximum number of cell reselections to enter Medium-mobility state.
NCR_H - This specifies the maximum number of cell reselections to enter High-mobility state.
NCR_NTN - This specifies the maximum number of cell reselections to enter NTN-moving sell-mobility state.
TCRmaxHyst -This specifies the additional time period before the UE can enter Normal-mobility state.
Speed dependent ScalingFactor for Qhyst - This specifies scaling factor for Qhyst in sf-High for High-mobility state and sf-Medium for
Medium-mobility state.
Speed dependent ScalingFactor for TreselectionNR - This specifies scaling factor for TreselectionNR in sf-High for High-mobility state and
sf-Medium for Medium-mobility state.
Speed dependent ScalingFactor for TreselectionEUTRA - This specifies scaling factor for TreselectionEUTRA in sf-High for High-mobility
state and sf-Medium for Medium-mobility state.

TABLE 7
NCRT with NTN attributes

| Neighbor Cell Relation | | OAM controlled attributes | | | |
|---|---|---|---|---|---|
| NCR | PCI | No Remove | No HO | No Xn | t1-t2 |
| 1 | PCI 1 | | | | 0:10-0:20 |
| 2 | PCI 1 | | X | | 0:20-23:59 |
| 3 | PCI 2 | | | X | |

-- ASN1START
-- TAG-MEASGAPCONFIG-START

| MeasGapConfig ::= | SEQUENCE { | |
|---|---|---|
| gapFR2 | SetupRelease { GapConfig } OPTIONAL, | -- Need M |

```
  ...,
  [[
```

| | | |
|---|---|---|
| gapFR1 | SetupRelease { GapConfig } OPTIONAL, | -- Need M |
| gapUE | SetupRelease { GapConfig } OPTIONAL | -- Need M |

]]
}

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6}, |
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |
| | OPTIONAL -- Cond NEDCorNRDC |

```
  ]],
  [[
```

| | |
|---|---|
| refFR2ServCellAsyncCA-r16 | ServCellIndex OPTIONAL, -- Cond AsyncCA |
| mgl-r16 | ENUMERATED {ms10, ms20} OPTIONAL -- Cond PRS |
| ]] | |

}
-- TAG-MEASGAPCONFIG-STOP
-- ASN1STOP

-- ASN1START
-- TAG-MEASGAPCONFIG-START

| MeasGapConfig ::= | SEQUENCE { | |
|---|---|---|
| gapFR2 | SetupRelease { GapConfig } OPTIONAL, | -- Need M |

```
  ...,
  [[
```

| | | |
|---|---|---|
| gapFR1 | SetupRelease { GapConfig } OPTIONAL, | -- Need M |
| gapUE | SetupRelease { GapConfig } OPTIONAL, | -- Need M |

| | |
|---|---|
| gapNTNLEO | SEQUENCE (SIZE (1..maxNTN-r17)) OF SetupRelease { GapConfig } |

| | |
|---|---|
| OPTIONAL, | -- Need M |

| | |
|---|---|
| gapNTNMEO | SEQUENCE (SIZE (1..maxNTN-r17)) OF SetupRelease { GapConfig } |

OPTIONAL, -- Need M

| | |
|---|---|
| gapNTNGEO | SEQUENCE (SIZE (1..maxNTN-r17)) OF SetupRelease { GapConfig } |

OPTIONAL, -- Need M

| | |
|---|---|
| gapNTNHAPS | SEQUENCE (SIZE (1..maxNTN-r17)) OF SetupRelease { GapConfig } |

OPTIONAL, -- Need M

]]
}

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6}, |
| mgrp | ENUMERATED {ms20, ms40, ms80, ms160}, |
| mgta | ENUMERATED {ms0, ms0dot25, ms0dot5}, |

```
  ...,
  [[
```

| | |
|---|---|
| refServCellIndicator | ENUMERATED {pCell, pSCell, mcg-FR2} |

OPTIONAL -- Cond NEDCorNRDC

```
  ]],
  [[
```

| | |
|---|---|
| refFR2ServCellAsyncCA-r16 | ServCellIndex |

OPTIONAL, -- Cond AsyncCA

| | |
|---|---|
| mgl-r16, | ENUMERATED {ms10, ms20} |

OPTIONAL, -- Cond PRS

| | |
|---|---|
| mgl-r17 | ENUMERATED {ms40, ms80, ...} |

OPTIONAL, -- Cond NTN

| | |
|---|---|
| gapOffsetNTN | INTEGER (−511..512) |

OPTIONAL -- Cond NTN
]]
}
-- TAG-MEASGAPCONFIG-STOP
-- ASN1STOP

5.6 MeasGapConfig information element field descriptions

gapFR1 - Indicates measurement gap configuration that applies to FR1 only. In (NG)EN-DC, gapFR1 cannot be set up by NR RRC
(i.e., only LTE RRC can configure FR1 measurement gap). In NE-DC, gapFR1 can only be set up by NR RRC (i.e., LTE RRC cannot
configure FR1 gap). In NR-DC, gapFR1 can only be set up in the measConfig associated with MCG. gapFR1 cannot be configured
together with gapUE. The applicability of the FR1 measurement gap is according to Table 9.1.2-2 and Table 9.1.2-3 in TS 38.133.
gapFR2 - Indicates measurement gap configuration applies to FR2 only. In (NG)EN-DC or NE-DC, gapFR2 can only be set up by NR
RRC (i.e., LTE RRC cannot configure FR2 gap). In NR-DC, gapFR2 can only be set up in the measConfig associated with MCG. gapFR2
cannot be configured together with gapUE. The applicability of the FR2 measurement gap is according to Table 9.1.2-2 and Table
9.1.2-3 in TS 38.133.
gapUE - Indicates measurement gap configuration that applies to all frequencies (FR1 and FR2). In (NG)EN-DC, gapUE cannot be
set up by NR RRC (i.e., only LTE RRC can configure per UE measurement gap). In NE-DC, gapUE can only be set up by NR RRC (i.e.,
LTE RRC cannot configure per UE gap). In NR-DC, gapUE can only be set up in the measConfig associated with MCG. If gapUE is
configured, then neither gapFR1 nor gapFR2 can be configured. The applicability of the per UE measurement gap is according to
Table 9.1.2-2 and Table 9.1.2-3 in TS 38.133.
gapNTNLEO - Indicates measurement gap configuration that applies to all frequencies (FR1 and FR2) for NTN LEO scenarios within
the measConfig associated with MCG.
gapNTNMEO - Indicates measurement gap configuration that applies to all frequencies (FR1 and FR2) for NTN MEO scenarios
within the measConfig associated with MCG.
gapNTNGEO - Indicates measurement gap configuration that applies to all frequencies (FR1 and FR2) for NTN GEO scenarios
within the measConfig associated with MCG.
gapNTNHAPS - Indicates measurement gap configuration that applies to all frequencies (FR1 and FR2) for NTN HAPS scenarios
within the measConfig associated with MCG.
gapOffset -Value gapOffset is the gap offset of the gap pattern with MGRP indicated in the field mgrp. The value range is from 0
to mgrp-1.
mgl - Value mgl is the measurement gap length in ms of the measurement gap. The measurement gap length is according to in
Table 9.1.2-1 in TS 38.133. Value ms1dot5 corresponds to 1.5 ms, ms3 corresponds to 3 ms and so on. If mgl-r16 is present, UE
shall ignore the mgl (without suffix).
mgrp - Value mgrp is measurement gap repetition period in (ms) of the measurement gap. The measurement gap repetition
period is according to Table 9.1.2-1 in TS 38.133.
mgta - Value mgta is the measurement gap timing advance in mS. The applicability of the measurement gap timing advance is
according to clause 9.1.2 of TS 38.133. Value ms0 corresponds to 0 ms, ms0dot25 corresponds to 0.25 ms and ms0dot5
corresponds to 0.5 mS. For FR2, the network only configures 0 ms and 0.25 mS.
refFR2ServCellIAsyncCA -Indicates the FR2 serving cell identifier whose SFN and subframe is used for FR2 gap calculation for this
gap pattern with asynchronous CA involving FR2 carrier(s).
refServCellIndicator - Indicates the serving cell whose SFN and subframe are used for gap calculation for this gap pattern. Value
pCell corresponds to the PCell, pSCell corresponds to the PSCell, and mcg-FR2 corresponds to a serving cell on FR2 frequency in
MCG.
gapOffsetNTN -Value gapOffsetNTN is the gap timing offset of the gap pattern for NTN scenarios based on the timing on the
reference cell. Values are specified in mS. Alternatively, values may be specified as μs, number of symbols, slots.

### Appendix 2

### Exhibit A

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1>set POWER_OFFSET_2STEP_RA to 0 dB;
1> if the carrier to use for the Random Access procedure is explicitly signalled:
   2> select the signalled carrier for performing Random Access procedure;
   2> set the PCMAX to P_{CMAX,f,c} of the signalled carrier.
1> else if the carrier to use for the Random Access procedure is not explicitly signalled; and
1> if the Serving Cell for the Random Access procedure is configured with supplementary uplink as specified in TS 38.331; and
1> if the RSRP of the downlink pathloss reference is less than rsrp-ThresholdSSB-SUL:
   2> select the SUL carrier for performing Random Access procedure;
   2> set the PCMAX to P_{CMAX,f,c} of the SUL carrier.
1> else:
   2> select the NUL carrier for performing Random Access procedure;
   2> set the PCMAX to P_{CMAX,f,c} of the NUL carrier.
1> perform the BWP operation as specified in clause 5.15;
1> if the Random Access procedure is initiated by PDCCH order and if the ra-Preamblelndex explicitly provided by PDCCH is not 0b000000; or
1> if the Random Access procedure was initiated for SI request (as specified in TS 38.331) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA TYPE to 4-stepRA.
1> else if the BWP selected for Random Access procedure is configured with both 2-step and 4-step RA type Random Access Resources and the RSRP of the downlink pathloss reference is above msgA-RSRP-Threshold; or
1> if the BWP selected for Random Access procedure is only configured with 2-step RA type Random Access resources (e.g., no 4-step RACH RA type resources configured); or
1> if the Random Access procedure was initiated for reconfiguration with sync and if the contention-free Random Access Resources for 2-step RA type have been explicitly provided in rach-ConfigDedicated for the BWP selected for Random Access procedure; or
   2> set the RA TYPE to 2-stepRA.
1> else:
   2> set the RA TYPE to 4-stepRA.

### Exhibit B

if lowMobilityEvaluation is configured and cellEdgeEvaluation is not configured; and,
if the UE has performed normal intra-frequency or inter-frequency measurements for at least T_{SearchDeltaP} after (re-)selecting a new cell; and,
if the relaxed measurement criterion in clause 5.2.4.9.1 is fulfilled for a period of T_{SearchDeltaP}:
   the UE may choose to perform relaxed measurements for intra-frequency, NR inter-frequency, or inter-RAT frequency cells according to relaxation methods in clauses 4.2.2.8, 4.2.2.9, and 4.2.2.10 in TS 38.133;
if cellEdgeEvaluation is configured and lowMobilityEvaluation is not configured; and,
if the relaxed measurement criterion in clause 5.2.4.9.2 is fulfilled:
   the UE may choose to perform relaxed measurements for intra-frequency, NR inter-frequency, or inter-RAT frequency cells according to relaxation methods in clauses 4.2.2.8, 4.2.2.9, and 4.2.2.10 in TS 38.133;
if both lowMobilityEvaluation and cellEdgeEvaluation are configured; and,
if combineRelaxedMeasCondition is not configured:
   if the UE has performed normal intra-frequency or inter-frequency measurements for at least T_{SearchDeltaP} after (re-)selecting a new cell, and, the relaxed measurement criterion in clause 5.2.4.9.1 is fulfilled for a period of T_{searchDeltaP}; or,
   if the relaxed measurement criterion in clause 5.2.4.9.2 is fulfilled:
      the UE may choose to perform relaxed measurements for intra-frequency, NR inter-frequency, or inter-RAT frequency cells according to relaxation methods in clauses 4.2.2.8, 4.2.2.9, and 4.2.2.10 in TS 38.133;
if both lowMobilityEvaluation and cellEdgeEvaluation are configured; and,
if the UE has performed normal intra-frequency or inter-frequency measurements for at least T_{searcDeitaP} after (re-)selecting a new cell; and,
if less than 1 hour has passed since measurements for cell (re-)selection were last performed; and,
if the relaxed measurement criterion in clause 5.2.4.9.1 is fulfilled for a period of TSearchDeltaP; and,
if the relaxed measurement criterion in clause 5.2.4.9.2 is fulfilled:
   the UE may choose not to perform measurement for measurements of intra-frequency, NR inter-frequencies of equal or lower priority, or inter-RAT frequency cells of equal or lower priority;
   if highPriorityMeasRelax is configured with value true:
      the UE may choose not to perform measurement for measurements of NR inter-frequencies or inter-RAT frequency cells of higher priority;
if lowMobilityEvaluation is configured and cellEdgeEvaluation is not configured; and,
if the serving cell fulfils Srxlev> SnonIntraSearchP and Squal>SnonIntrasearchQ; and,
if the UE has performed normal intra-frequency or inter-frequency measurements for at least TsearcDeitaP after (re-)selecting a new cell; and,
if less than 1 hour have passed since measurements for cell (re-)selection were last performed; and,
if the relaxed measurement criterion in clause 5.2.4.9.1 is fulfilled for a period of TSearchDetaP; and,
if highPriorityMeasRelax is configured with value true:
   the UE may choose not to perform measurement for measurements of NR inter-frequencies or inter-RAT frequency cells of higher priority;
if both lowMobilityEvaluation and cellEdgeEvaluation are configured; and,
if the serving cell fulfils Srxlev<SnonintraSearchP or Squal<SnonintrasearchQ; and,
if the UE has performed normal intra-frequency or inter-frequency measurements for at least TSearchDeltaP after (re-)selecting a new cell; and,
if less than T_{higher_priority_search} (see clause 4.2.2.7 in TS 38.133) has passed since measurements for cell (re-)selection were last performed; and,
if the relaxed measurement criterion in clause 5.2.4.9.1 is fulfilled for a period of TSearchDeltaP; and,
if the relaxed measurement criterion in clause 5.2.4.9.2 is fulfilled; and,
if highPriorityMeasRelax is not configured:
   the UE may choose not to perform measurement for measurements of NR inter-frequencies or inter-RAT frequency cells of higher priority.
if lowMobilityEvaluation is configured and cellEdgeEvaluation is not configured; and,
if NTN-type=GEO for the serving cell
if highPriorityMeasRelax is configured with value true:
   the UE may choose not to perform measurement for measurements of NR inter-frequencies or inter-RAT frequency cells of higher priority;

### Exhibit C

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1> set POWER_OFFSET_2STEP_RA to 0 dB;
1> if the carrier to use for the Random Access procedure is explicitly signalled:
   2> select the signalled carrier for performing Random Access procedure;
   2> set the PCMAX to P_{CMAX,f,c} of the signalled carrier.
1>else if the carrier to use for the Random Access procedure is not explicitly signalled; and
1> if the Serving Cell for the Random Access procedure is configured with supplementary uplink as specified in TS 38.331; and
1> if the RSRP of the downlink pathloss reference is less than rsrp-ThresholdSSB-SUL:
   2> select the SUL carrier for performing Random Access procedure;
   2> set the PCMAX to P_{CMAX,f,c} of the SUL carrier.
1> else:
   2> select the NUL carrier for performing Random Access procedure;
   2> set the PCMAX to P_{CMAX,f,c} of the NUL carrier.
1> perform the BWP operation as specified in clause 5.15;
1> if the Random Access procedure is initiated by PDCCH order and if the ra-Preamblelndex explicitly provided by PDCCH is not 0b000000; or
1> if the Random Access procedure was initiated for SI request (as specified in TS 38.331) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA TYPE to 4-stepRA.
1> else if the BWP selected for Random Access procedure is configured with both 2-step and 4-step RA type Random Access Resources and the RSRP of the downlink pathloss reference is above msgA-RSRP-Threshold; or
1> if the BWP selected for Random Access procedure is only configured with 2-step RA type Random Access resources (e.g., no 4-step RACH RA type resources configured); or
1> if the Random Access procedure was initiated for reconfiguration with sync and if the contention-free Random Access Resources for 2-step RA type have been explicitly provided in rach-ConfigDedicated for the BWP selected for Random Access procedure; or
For NTN, we propose the following enhancement:
1> if the Random Access procedure was initiated for SpCell that is associated with an NTN platform and the BWP selected for Random Access procedure is configured with both 2-step and 4-step RA type Random Access Resources and [e.g., Location=True, NTNCellEdge=False and EphemerisExpiration=False],
   2> set the RA TYPE to 2-stepRA.
1> else:
   2> set the RA TYPE to 4-stepRA.

### Exhibit D

The UE shall:
1> delete any stored version of a SIB associated with a TN after 3 hours from the moment it was successfully confirmed as valid;
1> delete any stored version of a SIB associated with an NTN [dependent upon the number of earth orbits for earth-moving (or other factors, e.g., new ephemeris) or extended for earth-fixed NTN cells] from the moment it was successfully confirmed as valid;
1> for each stored version of a SIB:
   2> if the stored version of a SIB is associated with an NTN:
      3> if the satellite ephemeris is valid
         4> consider the stored SIB as valid for the cell
   2> if the areaScope is associated and its value for the stored version of the SIB is the same as the value received in the si-Schedulinglnfo for that SIB from the serving cell:
      3> if the UE is NPN capable and the cell is an NPN-only cell and the first NPN identity included in the NPN-, the systemInformationArealD and the value Tag that are included in the si-Schedulinglnfo for the SIB received from the serving cell are identical to the NPN identity, the systemInformationArealD and the valueTag associated with the stored version of that SIB:
         4> consider the stored SIB as valid for the cell;
      3> else if the first PLMN-Identity included in the PLMN-IdentitylnfoList, the systemInformationArealD and the value Tag that are included in the si-SchedulingInfo for the SIB received from the serving cell are identical to the PLMN-Identity, the systemInformationArealD and the valueTag associated with the stored version of that SIB:
         4> consider the stored SIB as valid for the cell;
   2> if the areaScope is not present for the stored version of the SIB and the areaScope value is not included in the si-Schedulinglnfo for that SIB from the serving cell:
      3> if the UE is NPN capable and the cell is an NPN-only cell and the first NPN identity in the NPN-IdentitylnfoList, the cellIdentity and valueTag that are included in the si-SchedulingInfo for the SIB received from the serving cell are identical to the NPN identity, the cellIdentity and the valueTag associated with the stored version of that SIB:
         4> consider the stored SIB as valid for the cell;
      3> else if the first PLMN-Identity in the PLMN-IdentitylnfoList, the cellIdentity and valueTag that are included in the si-Schedulinglnfo for the SIB received from the serving cell are identical to the PLMN-Identity, the cellIdentity and the valueTag associated with the stored version of that SIB:
         4> consider the stored SIB as valid for the cell;

1-12. (canceled)

13. A method performed by a wireless transmit/receive unit (WTRU) configured with timing advance (TA) parameters specific to non-terrestrial network (NTN) cell types, the method comprising:
identifying one or more cells via a cell identification search;
determining that one of the one or more cells comprises a NTN cell;
determining TA reporting configuration information for the NTN cell based on a cell type of the NTN cell and according to the TA parameters; and
sending, to the NTN cell, a TA report according to the TA reporting configuration information.

14. The method of claim 13, wherein the TA parameters comprise WTRU-specific position parameters, WTRU-specific TA reporting parameters, cell-specific TA compensation parameters, or a combination thereof.

15. The method of claim 13, wherein the WTRU is preconfigured with the TA parameters.

16. The method of claim 13, wherein determining the TA reporting configuration information for the NTN cell is further based on ephemeris data of the NTN cell.

17. The method of claim 16, further comprising:
receiving correction data for the ephemeris data; and
storing updated ephemeris data according to the correction data.

18. The method of claim 16, wherein the ephemeris data comprises square root of semi-major axis information, eccentricity information, inclination angle information, longitude of ascending node of orbit plane information, argument of perigee information, mean anomaly at reference time information, ephemeris reference time information, or a combination thereof.

19. The method of claim 13, wherein determining the one of the one or more cells comprises a NTN cell further comprises:
receiving system information for the NTN cell;
determining timing relationship offset information for the NTN cell from the system information; and
determining a cell type for the NTN cell based on the timing relationship offset information.

20. The method of claim 13, wherein the cell type comprises High Altitude Platform Station (HAPS), Geostationary Earth Orbit (GEO), Low Earth Orbit (LEO), Medium Earth Orbit (MEO), or Highly Elliptical Orbit (HEO).

21. The method of claim 13, further comprising:
receiving additional configuration information via Radio Resource Control (RRC) communications, Media Access Control (MAC) control element (CE) communications, or both, and wherein the TA reporting configuration is further according to the additional configuration information.

22. The method of claim 13, wherein the one or more cells further comprise at least one terrestrial network (TN) cell.

23. A wireless transmit/receive unit (WTRU) comprising a processor and memory, wherein the WTRU is configured with timing advance (TA) parameters specific to non-terrestrial network (NTN) cell types, and wherein the WTRU is configured to:
identify one or more cells via a cell identification search;
determine that one of the one or more cells comprises a NTN cell;
determine TA reporting configuration information for the NTN cell based on a cell type of the NTN cell and according to the TA parameters; and
send, to the NTN cell, a TA report according to the TA reporting configuration information.

24. The WTRU of claim 23, wherein the TA parameters comprise WTRU-specific position parameters, WTRU-specific TA reporting parameters, cell-specific TA compensation parameters, or a combination thereof.

25. The WTRU of claim 23, wherein the WTRU is preconfigured with the TA parameters.

26. The WTRU of claim 23, wherein determining the TA reporting configuration information for the NTN cell is further based on ephemeris data of the NTN cell.

27. The WTRU of claim 26, wherein the WTRU is further configured to:
receive correction data for the ephemeris data; and
store updated ephemeris data according to the correction data.

28. The WTRU of claim 26, wherein the ephemeris data comprises square root of semi-major axis information, eccentricity information, inclination angle information, longitude of ascending node of orbit plane information, argument of perigee information, mean anomaly at reference time information, ephemeris reference time information, or a combination thereof.

29. The WTRU of claim 23, wherein determining the one of the one or more cells comprises a NTN cell further comprises:
receiving system information for the NTN cell;
determining timing relationship offset information for the NTN cell from the system information; and
determining a cell type for the NTN cell based on the timing relationship offset information.

30. The WTRU of claim 23, wherein the cell type comprises High Altitude Platform Station (HAPS), Geostationary Earth Orbit (GEO), Low Earth Orbit (LEO), Medium Earth Orbit (MEO), or Highly Elliptical Orbit (HEO).

31. The WTRU of claim 23, wherein the WTRU is further configured to:
receive additional configuration information via Radio Resource Control (RRC) communications, Media Access Control (MAC) control element (CE) communications, or both, and wherein the TA reporting configuration is further according to the additional configuration information.

32. The WTRU of claim 23, wherein the one or more cells further comprise at least one terrestrial network (TN) cell.
